(19) United States
(12) Patent Application Publication
(10) Pub. No.: US 2024/0162417 A1
(43) Pub. Date: May 16, 2024

(54) LAYERED ELECTRODE

(71) Applicant: Rivian IP Holdings, LLC, Plymouth, MI (US)

(72) Inventors: Yumi Kim, San Jose, CA (US); Soo Kim, Fremont, CA (US); Byoungchul You, Saratoga, CA (US); Sookyung Jeong, San Jose, CA (US); Hyuksang Park, San Jose, CA (US); Tae Kyoung Kim, Albany, CA (US); Ki Tae Park, Santa Clara, CA (US); Meng Wang, Pleasanton, CA (US)

(21) Appl. No.: 18/054,661

(22) Filed: Nov. 11, 2022

(51) Int. Cl. H01M 4/36; H01M 4/04; H01M 4/131; H01M 4/136; H01M 4/1391; H01M 4/1397; H01M 4/62

(52) U.S. Cl. CPC H01M 4/366; H01M 4/0404; H01M 4/131; H01M 4/136; H01M 4/1391; H01M 4/1397; H01M 4/621; H01M 4/624; H01M 2004/021

(57) ABSTRACT

An apparatus can include a layered electrode. The layered electrode can include a current collector material including a first side. The layered electrode can include a first electrode layer applied to the first side of the current collector material, the first electrode layer including a first applied viscosity of a first slurry. The layered electrode can include a second electrode layer applied to the first electrode layer, the second electrode layer including a second applied viscosity of a second slurry. The first applied viscosity of the first slurry can be greater than the second applied viscosity of the second slurry.

### INTRODUCTION

Vehicles can use electricity to power a motor. Electricity can be provided by a battery to operate the vehicle or components thereof.

### SUMMARY

The present disclosure is directed to a battery electrode, such as a layered battery electrode. The battery electrode can be used in a jelly roll or electrode layer stack within a battery cell, such as a battery cell for an electric vehicle. The battery electrode can include multiple electrode layers laminated to at least one of two sides of a current collector material. The multiple electrode layers can include a first electrode layer having characteristics that are different than the second electrode layer. For example, the first electrode layer can include a material characteristic to provide an increased energy density of the battery electrode while the second electrode layer can include a material characteristic to increase a power density of the battery electrode. The first electrode layer can include a first viscosity of a first slurry before coating and the second electrode layer can include a second viscosity of a second slurry before coating, where the first viscosity is higher than the second viscosity. The first electrode layer can include a higher solid content of the slurry before coating than the second electrode layer. The multiple electrode layers can include an active material, a binder material, or a conductive material. For example, the conductive material can conduct ions, such as negatively charged particles (e.g., electrons), positively charged particles (e.g., protons), cations, anions, negatively charged molecules or atoms, positively charged molecules or atoms, or some other ions.

At least one aspect is directed to an apparatus. The apparatus can be a layered electrode. The layered electrode can include a current collector material including a first side. The layered electrode can include a first electrode layer applied to the first side of the current collector material, the first electrode layer including a first applied viscosity of a first slurry. The layered electrode can include a second electrode layer applied to the first electrode layer, the second electrode layer including a second applied viscosity of a second slurry. The first applied viscosity of the first slurry can be greater than the second applied viscosity of the second slurry.

At least one aspect is directed to a method. The method can include providing a current collector including a first side and applying a first electrode layer to the first side of the current collector material. The first electrode layer can include a first applied viscosity of a first slurry and a first solid content by weight of the first slurry. The method can include applying a second electrode layer to the first electrode layer. The second electrode layer can include a second applied viscosity of a second slurry and a second solid content by weight of the second slurry. The first solid content by weight can be greater than the second solid content by weight and the first applied viscosity of the first slurry can be greater than the second applied viscosity of the second slurry.

At least one aspect is directed to a battery cell. The battery cell can include a battery electrode. The battery electrode can include a current collector material including a first side and a first electrode layer applied to the first side of the current collector material. The first electrode layer can include a first applied viscosity of a first slurry. The battery electrode can include a second electrode layer applied to the first electrode layer. The second electrode layer can include a second applied viscosity of a second slurry before coating. The first applied viscosity of the first slurry can be greater than the second applied viscosity of a second slurry.

At least one aspect is directed to an electric vehicle. The electric vehicle can include a battery cell. The battery cell can include a battery electrode. The battery electrode can include a current collector material including a first side and a first electrode layer applied to the first side of the current collector material. The first electrode layer can include a first applied viscosity of a first slurry. The battery electrode can include a second electrode layer applied to the first electrode layer. The second electrode layer can include a second applied viscosity of a second slurry before coating. The first applied viscosity of the first slurry can be greater than the second applied viscosity of the second slurry.

At least one aspect is directed to a method. The method can include providing a battery cell. The battery cell can include a battery electrode. The battery electrode can include a current collector material including a first side and a first electrode layer applied to the first side of the current collector material. The first electrode layer can include a first applied viscosity of a first slurry. The battery electrode can include a second electrode layer applied to the first electrode layer. The second electrode layer can include a second applied viscosity of a second slurry before coating. The first applied viscosity of the first slurry can be greater than the second applied viscosity of the second slurry.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example battery electrode, in accordance with some aspects.

FIG. 2 depicts an example battery electrode, in accordance with some aspects.

FIG. 3 depicts an example battery electrode, in accordance with some aspects.

FIG. 4 depicts an example slot die coating system, in accordance with some aspects.

FIG. 5 is a flow chart of an example method of manufacturing a battery electrode, in accordance with some aspects.

FIG. 6 depicts an example electric vehicle, in accordance with some aspects.

FIG. 7 depicts an example battery pack, in accordance with some aspects.

FIG. 8 depicts an example battery module, in accordance with some aspects.

FIG. 9 depicts a cross sectional view of an example battery cell, in accordance with some aspects.

FIG. 10 depicts a cross sectional view of an example battery cell, in accordance with some aspects.

FIG. 11 depicts a cross sectional view of a battery cell, in accordance with some aspects.

FIG. 12 is a flow chart of an example method of providing an electrode, in accordance with some aspects.

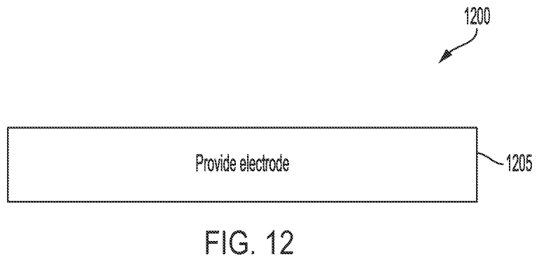

### DETAILED DESCRIPTION

Following below are more detailed descriptions of various concepts related to, and implementations of, methods, apparatuses, and systems related to battery electrodes. The various concepts introduced above and discussed in greater detail below may be implemented in any of numerous ways.

The present disclosure is directed to a battery electrode. For example, the battery electrode can be used in a jelly roll or electrode layer stack within a battery cell, such as a battery cell for an electric vehicle or other device. The battery electrode can include multiple electrode layers laminated to at least one of two sides of a current collector material. The multiple electrode layers can include a first electrode layer having characteristics that are different than the second electrode layer, where the first electrode layer can include a material characteristic to provide an increased energy density of the battery electrode. The second electrode layer can include a material characteristic to increase a power density of the battery electrode. For example, the first electrode layer can include a first viscosity of the slurry before coating and the second electrode layer can include a second viscosity of the slurry before coating, where the first viscosity is higher than the second viscosity. The first electrode layer can include larger solid particles (e.g., active material, binder, conductive carbon) with less solvent (e.g., NMP solvent) that can create a higher viscosity than the second electrode layer, which can include smaller solid particles (e.g., active material, binder, conductive carbon) with more solvent (e.g., NMP solvent). The battery electrode can include at least one buffer layer positioned between the current collector material and the first electrode layer or between the first electrode layer and the second electrode layer. The buffer layer can increase adhesion of the first electrode layer to the current collector material or the second electrode layer to the first electrode layer. The buffer layer can increase conductivity between the first electrode layer and the current collector material or between the second electrode layer and the first electrode layer.

The disclosed solutions have a technical advantage of having a first electrode layer with a higher viscosity of the slurry before coating than a second electrode layer to achieve a desirable energy density of the battery electrode (e.g., achieve higher loading) while simultaneously including the second electrode layer to maintain a uniform surface morphology and achieve a desirable power density. The battery electrode can include a current collector material including a first side and a second side. The battery electrode can two or more electrode layers laminated to each of the first side and the second side. For example, the battery electrode can include a first electrode layer applied to the first side of the current collector material. The battery electrode can include a second electrode layer applied to the first electrode layer. For example, the battery electrode can include the first electrode layer having a higher viscosity of the slurry (e.g., >7k centipoise, 5-7k centipoise) to achieve a desirable loading level (e.g., single sided: 15-25 mg/cm², double-sided: 25-50 mg/cm², greater than 50 mg/cm²). The battery electrode can include the second electrode layer having a lower viscosity of the slurry before coating (e.g., 1-7k centipoise, 1-5k centipoise, less than 7k centipoise) to achieve a uniform surface morphology, when dried. The battery electrode can achieve a loading level (e.g., an amount of active material per unit area or an energy density level) associated with viscous material of the first electrode layer while also achieving a surface morphology or power density associated with the relatively non-viscous material of the second electrode layer.

The battery electrode can include at least one buffer layer to improve conductivity or adhesion of the first or second electrode layer to the current collector material or the first electrode layer, respectively. The buffer layer can be a carbon layer that does not include any active material (e.g., a cathode active material or an anode active material). For example, the buffer layer can include a carbon conductivity agent or a binder material. The battery electrode can include a buffer layer positioned between the current collector material and the first electrode layer. For example, the buffer layer can include a binder material (e.g., polyvinylidenefluoride or some other material) to improve adhesion between the first electrode layer and the current collector material to reduce or substantially prevent (e.g., prevent 95% of) electrode delamination from the current collector material. The battery electrode can include a buffer layer positioned between the first electrode layer and the second electrode layer. The buffer layer can include a conductive material (e.g., carbon, granule, graphene, CNT, a conductive polymer, or other conductive material) to increase a conductivity between the first electrode layer and the second electrode layer by acting as an electrically-conducting interface. For example, the buffer layer can conduct ions, such as negatively charged particles (e.g., electrons), positively charged particles (e.g., protons), cations, anions, negatively charged molecules or atoms, positively charged molecules or atoms, or some other ions between the first electrode layer and the second electrode layer. The buffer layer can include the conductive material to minimize a material expansion between the first electrode layer and the second electrode layer. In another embodiment, the buffer layer can include the conductive polymer materials including but not limited to PEDOT-PSS. The battery electrode can include at least one buffer layer to impede a dissolution of a cathode active material or the deposition of metals from the cathode active material to an anode material. For example, the buffer layer can impede a dissolution of cathode active material during a high voltage operation of a battery cell including the battery electrode.

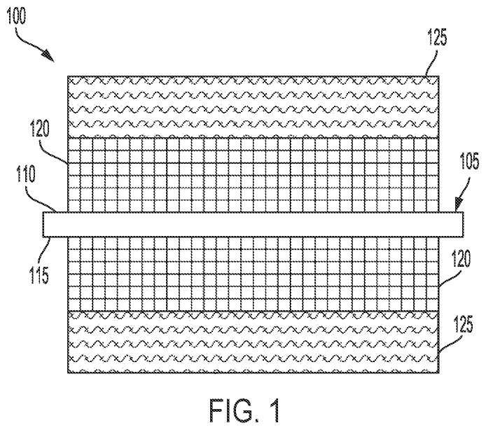

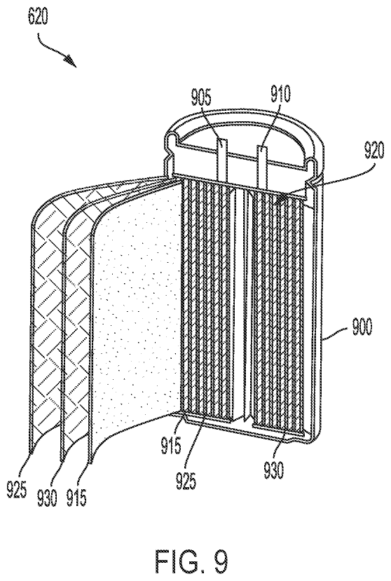

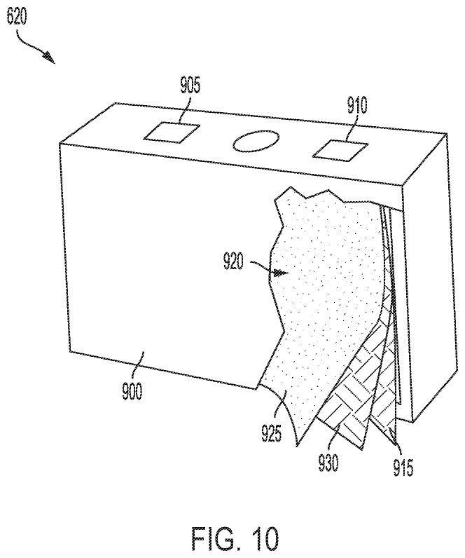

FIGS. 1-3, among others, depict an apparatus 100. The apparatus 100 can be a battery electrode 100. The electrode 100 can be a layered electrode including a first electrode layer 120 and a second electrode layer 125. The first electrode layer 120 can be laminated to a current collector material 105. The second electrode layer 125 can be applied to the first electrode layer 120. The electrode 100 can be a battery electrode for an electric vehicle or similar device or system. For example, the electrode 100 can be an electrode 100 that is used in an electrode layer stack for a prismatic battery cell (e.g., the battery cell 620 as shown in FIG. 10), in a jelly roll of a cylindrical battery cell (e.g., the battery cell 620 as depicted in FIG. 9, among others), or in some other battery cell. The electrode 100 can be a cathode electrode (e.g., an electrode having a cathode active material) or an anode electrode (e.g., an electrode having an anode active material).

The electrode 100 can include a current collector material 105. The current collector material 105 can include a first side 110 and a second side 115. For example, the current collector material 105 can be a layer, sheet, or web of having a first side 110 (e.g., an upper side) that is opposite a second side 115 (e.g., a lower side). The current collector material 105 can be or include a foil to which an electrode active material is laminated to form a cathode layer or an anode layer. The current collector material 105 can include a metal material. For example, the current collector material 105 can be or include at least one material including aluminum, copper, nickel, titanium, stainless steel, or carbonaceous materials. The current collector material can be formed as a metal foil. For example, the current collector material 105 can be an aluminum (Al) or copper (Cu) foil. The current collector material 105 can be a metal alloy, made of Al, Cu, Ni, Fe, Ti, or combination thereof. The current collector material 105 can be a metal foil coated with a carbon material, such as carbon-coated aluminum foil, carbon-coated copper foil, or other carbon-coated foil material.

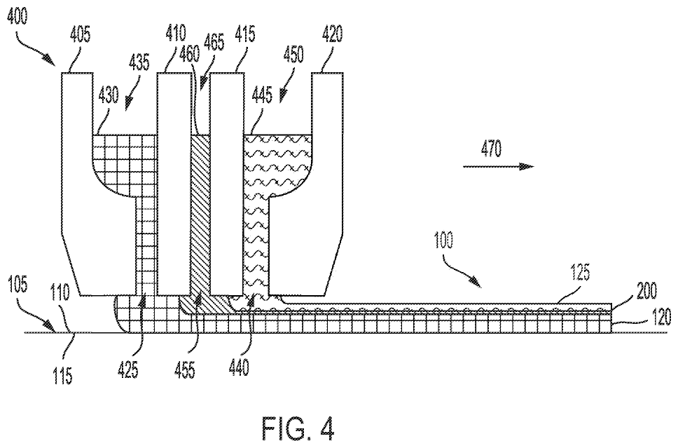

The electrode 100 can include a first electrode layer 120 applied to the first side 110 of the current collector material 105. For example, the electrode 100 can include the first electrode layer 120 applied via a slot die coating system or device, such as the slot die coating system 400 as depicted in FIG. 4, among others, to the first side 110 of the current collector material 105. The first electrode layer 120 can be applied to the current collector material 105 in an uncured or semi-liquid form. For example, the slot die coating system 400 can receive a slurry that can be applied to a surface (e.g., deposited onto a surface, layered over a surface, spread across a surface) of some material (e.g., the current collector material 105). The slurry can be a semi-liquid material that includes solid materials (e.g., solid particulate matter). The slurry can be applied to the first side 110 of the current collector material 105 to form the first electrode layer 120. The first electrode layer 120 can be applied to the first side 110 of the current collector material 105 with the first electrode layer 120 still in a slurry (e.g., semi-liquid) form. The first electrode layer 120 can be applied to the first side 110 of the current collector material 105 with the first electrode layer 120 in an uncured (e.g., wet, semi-liquid, soft, malleable) state. The first electrode layer 120 can be cured (e.g., heated, dried, or otherwise cured) to form a solid or semi-solid electrode layer after the first electrode layer 120 is applied to the current collector material 105. For example, after the first electrode layer 120 is applied to the current collector material 105 as a slurry or in an uncured form, the first electrode layer 120 and the current collector material 105 to which it is applied can be inserted or provided through an oven (e.g., a conveyor at least partially surrounded by heating elements). The first electrode layer 120 can be cured to form a solid or semi-solid first electrode layer 120 such that the first electrode layer 120 is no longer in a semi-liquid form. The first electrode layer 120 can be applied to the current collector material 105 with the first electrode layer 120 originating from a powdered form. For example, the first electrode layer 120 can be a powdered material that is compressed or sheared to form a film, where the film is applied (e.g., laminated) to the current collector material 105.

The electrode 100 can include an electrode layer applied to the first side 110 and the second side 115 of the current collector material 105. For example, the electrode 100 can include the first electrode layer 120 applied to the first side 110 of the current collector material 105 and the second side 115 of the current collector material 105. For example, the electrode 100 can include an upper first electrode layer 120 applied to the first side 110 of the current collector material 105 and a lower first electrode layer 120 applied to the second side 115 of the current collector material 105. The upper first electrode layer 120 and the lower first electrode layer 120 can be substantially similar (e.g., ±90% similar) with respect to physical or chemical properties. The upper first electrode layer 120 can be different than the lower first electrode layer 120. For example, the upper first electrode layer 120 can include a thickness that is greater than or less than a thickness of the lower first electrode layer 120.

The electrode 100 can include the first electrode layer 120 applied to the current collector material 105 with an intervening layer disposed therebetween. For example, an intervening layer (e.g., a buffer layer, an adhesive layer, or some other layer) can be positioned between the current collector material 105 and the first electrode layer 120. The electrode 100 can include a first intervening layer positioned between the upper first electrode layer 120 and the first side 110 of the current collector material 105. The electrode 100 can include a second intervening layer positioned between the lower first electrode layer 120 and the second side 115 of the current collector material 105.

The electrode 100 can include the first electrode layer 120 including a first solid content weight. For example, the first solid content of the first electrode layer 120 can include the at least one solid material. The first electrode layer 120 can be applied to the current collector material 105 as a slurry or semi-liquid material, where the slurry or semi-liquid material includes the first solid content. The first solid content can include multiple materials. For example, the first solid content can account for at least one first binder material, at least one first conductive material (e.g., carbon, granule, graphene, CNT, a conductive polymer, or other conductive material), and at least one first active material. The first solid content can include solid matter or solid particulate matter, where the solid matter or solid particulate can include at least one of the first binder material, first conductive material, the first active material, or some combination thereof. The solid content can include solid particulate having a size (e.g., cross-sectional area or volume) and shape (e.g., spherical, tetrahedral, irregular, or some other shape). For example, the first solid content can include solid particulate of cathode active material approximately (e.g., ±90%), 30 nm to 50 μm.

The first solid content of the first electrode layer 120 can constitute a percentage of the first electrode layer 120 by weight, volume, or some other variable. For example, the first electrode layer 120 can include the first solid content constituting 30-70% of the first electrode layer 120 by weight with the first electrode layer 120 in a slurry form (e.g., as the first electrode layer 120 is applied to the current collector material 105). The first solid content can be 30-75% of the first electrode layer 120 by weight with the first electrode layer 120 in a slurry form. The first solid content can be 40-60% of the first electrode layer 120 by weight with the first electrode layer 120 in a slurry form. The first solid content can be some other percentage of the first electrode layer 120 by weight with the first electrode layer 120 in a slurry form. In other examples, the first electrode layer 120 can originate as a dry powdered material, which can be sheared or compressed to form a film that is applied to the current collector material 105. In such instances, the first solid content of the dry powdered first electrode layer 120 can be 50-100% of the first electrode layer 120 by weight, 60-80% by weight, 30-50% by weight, or some other percentage by weight.

The electrode 100 can include the first solid content of the first electrode layer including a first binder material. The first binder material can include a first molecular weight. For example, the first binder material can include a molecular weight of approximately (e.g., ±15%) 800,000 g/mol. The first binder material of the first electrode layer 120 can include a molecular weight of greater than 800,000 g/mol or less than 800,000 g/mol. For example, the binder material can include a molecular weight between 600,000 g/mol and 1,200,000 g/mol. The first binder material can constitute 1-10% of the first solid content or of the first electrode layer 120 by weight. The first binder material can constitute less than 1% of the first solid content or of the first electrode layer 120 by weight. The first binder material can constitute greater than 10% of the first solid content or of the first electrode layer 120 by weight, for example. The first binder material can be or include polymeric materials such as polyvinylidenefluoride (PVDF), polyvinylpyrrolidone (PVP), styrene-butadiene or styrene-butadiene rubber (SBR), polytetrafluoroethylene (PTFE), carboxymethylcellulose (CMC), or some other material. The first binder material can include agar-agar, alginate, amylose, arabic gum, carrageenan, caseine, chitosan, cyclodextrines (carbonyl-beta), ethylene propylene diene monomer (EPDM) rubber, gelatin, gellan gum, guar gum, karaya gum, cellulose (natural) pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, tara gum, tragacanth gum, fluorine acrylate (TRD202A), xanthan gum, or some combination thereof.

The electrode 100 can include the first solid content of the first electrode layer 120 including a first conductive material (e.g., carbon, granule, graphene, CNT, a conductive polymer, or other conductive material). The first conductive material can include a first conductivity. For example, the first conductive material can facilitate the conduction of ions, such as negatively charged particles (e.g., electrons), positively charged particles (e.g., protons), cations, anions, negatively charged molecules or atoms, positively charged molecules or atoms, or some other ions from the first electrode layer 120 to another material, such as a second electrode layer, the current collector material 105, or another electrode 100. The first conductive material can be 0.5 to 5% by weight of the first solid content of the first electrode layer 120 or of the first electrode layer 120. The first conductive material can constitute less than 0.5% of the first solid content or of the first electrode layer 120 by weight. The first conductive material can constitute less than 5% of the first solid content or of the first electrode layer 120 by weight. The first conductive material can be carbon black (granule), CNT (carbon nanotubes), graphene, a conductive polymer, or some other conductive material. The electrode 100 can exhibit a lower interfacial resistance of the first electrode layer 120 with the first conductive material comprising a larger percentage of the first solid content or of the first electrode layer 120 by weight. The electrode 100 can include the first solid content of the first electrode layer 120 including multiple conductive materials. For example, the solid content of the first electrode layer 120 can include a first conductive material and a second conductive material. The first conductive material of the first solid content can include a first conductivity. The second conductive material of the first solid content can include a second conductivity. The first conductivity can be the same as or different than the second conductivity. The first conductive material can be carbon black (graphene), and the second conductive material can be CNT or graphene, for example.

The electrode 100 can include the first solid content of the first electrode layer 120 including a first active material. For example, the first active material can include a first chemistry. The first chemistry can be a nickel-based chemistry. For example, the first active material can be high-nickel based chemistry, such as an NMC (Nickel Manganese Cobalt) chemistry, an NCA (Nickel Cobalt Aluminum) chemistry, or some other chemistry. If the electrode 100 is a cathode electrode, for example, the first active material can include a medium to high-nickel content (50 to 80%, or greater than 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or other material. The first active material can include a lithium-based chemistry. For example, the first active material can be an LFP (Lithium iron phosphate) chemistry, an LMFP (Lithium iron manganese phosphate) chemistry, or some other chemistry. The first active material can include an activated carbon or a material infused with conductive materials (e.g., artificial or natural Graphite, or blended), lithium titanate (Li₄Ti₅O₁₂), a silicon-based material (e.g., silicon metal, oxide, carbide, pre-lithiated), lithium alloy anodes (Li—Mg, Li—Al, Li—Ag alloy etc.), or other composite anodes consisting of lithium and carbon, silicon and carbon or other compounds.

The first active material can comprise 90-99.5% by weight of the first solid content or the first electrode layer 120. For example, the first active material can be 93-96% by weight of the first solid content or the first electrode layer 120. The first active material can be less than 90% or more than 99.5% by weight of the first electrode layer 120. The first electrode layer 120 can include a loading level of approximately (e.g., ±25%) 0.1-45 mg/cm² with the active material comprising 90-99.5% by weight of the first solid content or the first electrode layer 120. For example, the electrode 100 can achieve a loading level of 15-25 mg/cm² for a single-sided electrode 100, 25-50 mg/cm² for a double sided electrode 100, or greater than 50 mg/cm². The first electrode layer 120 can include some other loading level with the active material comprising 90-99.5% by weight of the first solid content or the first electrode layer 120.

The electrode 100 can include the first electrode layer 120 including a first applied viscosity. The first applied viscosity can be a viscosity of a slurry or slurry mix before or as the slurry is applied to (e.g., coated on) the current collector material 105 or other surface. For example, the first electrode layer 120 can include a first applied viscosity of the slurry before coating as the first electrode layer 120 is applied and coated to the current collector material 105. As discussed below with reference to FIG. 4, among others, the first electrode layer 120 can be applied to the current collector material 105 via a slot die coating system or device. For example, a slot die coating system or device can apply a slurry (e.g., a semi-liquid mixture containing solid particles) to the current collector material 105. The slurry can be a semi-liquid mixture as it is applied to the current collector material 105, but can later solidify to form a solid or semi-solid electrode layer. For example, the first electrode layer 120 can be applied to the current collector material 105 in an uncured or semi-liquid form. The first electrode layer 120 can be cured (e.g., heated, dried, or otherwise cured) to form a solid or semi-solid electrode layer after the first electrode layer 120 is applied to the current collector material 105. The electrode 100 can be used within a battery cell, battery module, or battery pack with the first electrode layer 120 in a cured state.

The first electrode layer 120 can include a first applied viscosity with the first electrode layer 120 in a slurry (e.g., semi-liquid) form. For example, the first electrode layer 120 can be applied to the current collector material 105 in an uncured, semi-liquid state with the first electrode layer 120 having the first applied viscosity and the first electrode layer 120 can thereafter be cured to form a solid or semi-solid electrode layer. The first electrode layer 120 can include the first applied viscosity of the slurry before coating as the first electrode layer 120 is applied to the first side 110 or the second side 115 of the current collector material 105 by the slot die coating system or device. The first applied viscosity of the slurry before coating of the first electrode layer 120 can be a relatively high viscosity, such as 7,000 centipoise or greater than 7,000 centipoise. For example, the first applied viscosity of the slurry before coating of the first electrode layer 120 can be high (e.g., 7,000 centipoise or greater) with the first electrode layer 120 including a first solid content that is also relatively high (e.g., 50-70% by weight). The first solid content of the first electrode layer 120 can cause the first electrode layer 120 to be resistant to flow as the first electrode layer 120 is applied to the current collector material 105 by a slot die coating device or system. The first electrode layer 120 can include a high first applied viscosity of the slurry before coating because the first solid content can be composed of a relatively high percentage of solid particulate (e.g., 50-70% solid content or greater) or because the first solid content can be composed of solid particulate having a particle size from 30 nm to 50 μm.

The electrode 100 can include the first electrode layer 120 including a first porosity. For example, the electrode 100 can include the first electrode layer 120 including the first porosity with the first electrode layer 120 in a cured state. The first electrode layer 120 can be porous or semi-porous with the first electrode layer 120 in a solid or semi-solid state (e.g., after a slurry or semi-liquid first electrode layer 120 has been cured). For example, voids (e.g., openings, gaps, space) can exist between solid particles of the cured first electrode layer 120. The first solid content of the first electrode layer 120 can include solid particles of various sizes (e.g., 30 nm to 50 μm). The first solid content can include solid particles of various shapes (e.g., spherical, irregular, or other shape). Because the solid particles of the first solid content can have varying sizes or shapes, the voids can exist between adjacent solid particles. The first porosity can be representative of the percentage of void space within the first electrode layer 120 with the first electrode layer 120 in a cured state. For example, a cross-section of the first electrode layer 120 can reveal a first porosity including at least 20% or less than 40% of the cross-sectional area of the first electrode layer 120 being void space. The first electrode layer 120 can include a first porosity having a value between 0.28-0.35 on a scale of 0 to 1. For example, the first electrode layer 120 can include the first porosity having a porosity value of approximately (e.g., ±15%) 0.325. The first porosity can be some other representation of the void space of the first electrode layer 120 (e.g. volumetric measurement of void space).

The electrode 100 can include multiple electrode layers. For example, the electrode 100 can include at least one second electrode layer 125 applied to the first electrode layer 120. The electrode 100 can include the second electrode layer 125 applied via a slot die coating system or device, such as the slot die coating system 400 as depicted in FIG. 4, among others, to the first electrode layer 120 with the first electrode layer 120 applied to the first side 110 of the current collector material 105. The second electrode layer 125 can be applied to the first electrode layer 120 in an uncured or semi-liquid form. For example, the slot die coating system 400 can receive a slurry that can be applied to a surface (e.g., deposited onto a surface, layered over a surface, spread across a surface) of some material (e.g., the first electrode layer 120). The slurry can be a semi-liquid material that includes solid materials (e.g., solid particulate matter). The slurry can be applied to the first electrode layer 120 to form the second electrode layer 125. The second electrode layer 125 can be applied to the first electrode layer 120 with the second electrode layer 125 still in a slurry (e.g., semi-liquid) form. The second electrode layer 125 can be applied to the first electrode layer 120 with the second electrode layer 125 in an uncured (e.g., wet, semi-liquid, soft, malleable) state. The second electrode layer 125 can be cured (e.g., heated, dried, or otherwise cured) to form a solid or semi-solid electrode layer after the second electrode layer 125 is applied to the first electrode layer 120. For example, after the second electrode layer 125 is applied to the first electrode layer 120 as a slurry or in an uncured form, the second electrode layer 125, the first electrode layer 120 to which it is applied, and the current collector material 105 to which the first electrode layer 120 is applied can be inserted or provided through an oven (e.g., a conveyor at least partially surrounded by heating elements). The second electrode layer 125 can be cured to form a solid or semi-solid second electrode layer 125 such that the second electrode layer 125 is no longer in a semi-liquid form. The second electrode layer 125 can be applied to the first electrode layer 120 with the second electrode layer 125 originating from a powdered form. For example, the second electrode layer 125 can be a powdered material that is compressed or sheared to form a film, where the film is applied (e.g., laminated) to the first electrode layer 120.

The electrode 100 can include the second electrode layer 125 applied to the upper first electrode layer 120 and to the lower first electrode layer 120. For example, the electrode 100 can include an upper second electrode layer 125 applied to the upper first electrode layer 120. The electrode 100 can include a lower second electrode layer 125 applied to the lower first electrode layer 120. The upper second electrode layer 125 and the lower second electrode layer 125 can be substantially similar (e.g., ±90% similar) with respect to physical or chemical properties. The upper second electrode layer 125 can be different than the lower second electrode layer 125. For example, the upper second electrode layer 125 can include a thickness that is greater than or less than a thickness of the lower second electrode layer 125.

The electrode 100 can include the second electrode layer 125 applied to the current collector material 105 with an intervening layer disposed therebetween. For example, an intervening layer (e.g., a buffer layer, an adhesive layer, or some other layer) can be positioned between the first electrode layer 120 and the second electrode layer 125. The electrode 100 can include a first intervening layer positioned between the upper first electrode layer 120 and the upper second electrode layer 125. The electrode 100 can include a second intervening layer positioned between the lower first electrode layer 120 and the lower second electrode layer 125.

The electrode 100 can include the second electrode layer 125 including a second solid content. For example, the second solid content of the second electrode layer 125 can include the at least one solid material. The second electrode layer 125 can be applied to the first electrode layer 120 as a slurry or semi-liquid material, where the slurry or semi-liquid material includes the second solid content. The second solid content can include multiple materials. For example, the second solid content can include at least one second binder material, at least one second conductive material (e.g., carbon, granule, graphene, CNT, a conductive polymer, or other conductive material), and at least one second active material. The second solid content can include solid matter or solid particulate matter, where the solid matter or solid particulate can include at least one of the second binder material, second conductive material, the second active material, or some combination thereof. The solid content can include solid particulate having a size (e.g., cross-sectional area or volume) and shape (e.g., spherical, tetrahedral, irregular, or some other shape). For example, the first solid content can include solid particulate of cathode active material approximately (e.g., ±90%), 30 nm to 50 μm.

The second solid content of the second electrode layer 125 can constitute a percentage of the second electrode layer 125 by weight, volume, or some other variable. For example, the second electrode layer 125 can include the first solid content constituting 10-50% of the second electrode layer 125 by weight with the second electrode layer 125 in a slurry form (e.g., as the second electrode layer 125 is applied to the first electrode layer 120). The second solid content can be 10-55% of the second electrode layer 125 by weight with the second electrode layer 125 in a slurry form. The second solid content can be 15-45% of the second electrode layer 125 by weight with the second electrode layer 125 in a slurry form. The second solid content can be some other percentage of the second electrode layer 125 by weight with the second electrode layer 125 in a slurry form. In other examples, the second electrode layer 125 can originate as a dry powdered material, which can be sheared or compressed to form a film that is applied to the first electrode layer 120. In such instances, the second solid content of the dry powdered second electrode layer 125 can be 40-95% of the second electrode layer 125 by weight, 50-90% by weight, or some other percentage by weight.

The electrode 100 can include the first solid content of the first electrode layer 120 being greater than the second solid content of the second electrode layer 125. For example, the first solid content of the first electrode layer 120 can be greater by percentage of weight of the first electrode layer 120 than the second solid content of the second electrode layer 125. The first solid content of the first electrode layer 120, including for example the first binder material, the first conductive material, and the first active material, can constitute approximately (e.g., ±15%) 30-70% of the first electrode layer 120 by weight with the first electrode layer 120 in slurry form as it is applied to the current collector material 105. The second solid content of the second electrode layer 125, including for example the second binder material, the second conductive material, and the second active material, can constitute approximately (e.g., ±15%) 10-50% of the second electrode layer 125 by weight with the second electrode layer 125 in slurry form as it is applied to the first electrode layer 120.

The electrode 100 can include the second solid content of the second electrode layer 125 including a second binder material. The second binder material can include a second molecular weight. For example, the second binder material can include a molecular weight of approximately (e.g., ±15%) 600,000 g/mol. The second binder material of the second electrode layer 125 can include a molecular weight of greater than 600,000 g/mol, but less than 800,000 g/mol. For example, the second binder material can include a molecular weight of less than 800,000 g/mol. The second binder material can include a molecular weight between 600,000 g/mol and 1,200,000 g/mol, for example. The second binder material can constitute 0.3-5% of the second solid content or the second electrode layer 125 by weight. The second binder material can constitute less than 0.3% of the second solid content or the second electrode layer 125 by weight. The second binder material can constitute greater than 5% of the second solid content or the second electrode layer 125 by weight, for example. The second binder material can be or include polymeric materials such as polyvinylidenefluoride (PVDF), polyvinylpyrrolidone (PVP), styrene-butadiene or styrene-butadiene rubber (SBR), polytetrafluoroethylene (PTFE), carboxymethylcellulose (CMC, or some other material. The first binder material can include agar-agar, alginate, amylose, arabic gum, carrageenan, caseine, chitosan, cyclodextrines (carbonyl-beta), ethylene propylene diene monomer (EPDM) rubber, gelatin, gellan gum, guar gum, karaya gum, cellulose (natural) pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, tara gum, tragacanth gum, fluorine acrylate (TRD202A), xanthan gum, or some combination thereof.

The electrode 100 can include the second molecular weight of the second binder material being less than the first molecular weight of the first binder material. For example, the first electrode layer 120 can include the first binder material having the first molecular weight that is greater than 800,000 g/mol, for example. The second electrode layer 125 can include the second binder material having the second molecular weight that is less than 800,000 g/mol, for example. The first molecular weight of the first binder material can promote adhesion of the first electrode layer 120 to the current collector material 105. For example, the first binder material can cause the first electrode layer 120 to adhere to the current collector material 105 more reliably (e.g., with more retention force, with a reduced likelihood of delamination) than the second electrode layer 125 can adhere to the first electrode layer 120 with the first molecular weight of the first binder material being higher than the second molecular weight of the second binder material.

The electrode 100 can include the second solid content of the second electrode layer 125 including a second conductive material (e.g., carbon, granule, graphene, CNT, a conductive polymer, or other conductive material). The second conductive material can include a second conductivity. For example, the second conductive material can facilitate the conduction of ions from the second electrode layer 125 to another material, such as the first electrode layer 120, an electrolyte layer (e.g., separator layer), another electrode 100, or otherwise. The second conductive material can be 0.1 to 2% by weight of the second solid content of the second electrode layer 125 or of the second electrode layer 125 with the second electrode layer 125 in slurry form. The second conductive material can constitute less than 0.1% of the second solid content or second electrode layer 125 by weight. The second conductive material can constitute greater than 2% of the second solid content or second electrode layer 125 by weight. The second conductive material can be carbon black (granule), CNT (carbon nanotubes), graphene, a conductive polymer, or some other conductive material. The electrode 100 can include the second solid content of the second electrode layer 125 including multiple conductive materials. For example, the solid content of the second electrode layer 125 can include a first conductive material and a second conductive material. The first conductive material of the second solid content can include a first conductivity. The second conductive material of the second solid content can include a second conductivity. The first conductivity can be the same as or different than the second conductivity. The first conductive material of the second solid content can be carbon black (graphene), and the second conductive material of the second solid content can be CNT or graphene, for example.

The electrode 100 can include the second electrode layer 125 including a lower proportion of conductive material than the first electrode layer 120. For example, the second electrode layer 125 can include the second solid content including the second conductive material, where the second conductive material can constitute 0.1-2% of the second solid content or the second electrode layer 125 by weight. The first electrode layer 120 can include the first solid content including the first conductive material, where the first conductive material can constitute 0.5-5% of the first solid content or the first electrode layer 120 by weight. The first electrode layer 120 can include a higher conductivity than the second electrode layer 125 with the first electrode layer 120 including a greater proportion of conductive material than the second electrode layer 125. The first electrode layer 120 can include a lower interfacial resistance than the second electrode layer 125 with the first electrode layer including a higher proportion of conductive material than the second electrode layer 125.

The electrode 100 can include the second electrode layer 125 including a second active material. The second active material can include a second chemistry. For example, the second active material can include a lithium-based chemistry. For example, the second active material can be an LFP (Lithium iron phosphate) chemistry, an LMFP (Lithium iron manganese phosphate) chemistry, or some other chemistry. The second active material can include an activated carbon or a material infused with conductive materials (e.g., artificial or natural Graphite, or blended), lithium titanate (Li₄Ti₅O₁₂), a silicon-based material (e.g., silicon metal, oxide, carbide, pre-lithiated), lithium alloy anodes (Li—Mg, Li—Al, Li—Ag alloy etc.), or other composite anodes consisting of lithium and carbon, silicon and carbon or other compounds. The second active material can be high-nickel based chemistry, such as an NMC (Nickel Manganese Cobalt) chemistry, an NCA (Nickel Cobalt Aluminum) chemistry, or some other chemistry. If the electrode 100 is a cathode electrode, for example, the second active material can include a medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or other material. The electrode 100 can include the second electrode layer 125 including the second active material that is different than the first active material of the first electrode layer 120. For example, the first active material can be a nickel-based active material, while the second active material of the second electrode layer 125 can be a lithium iron phosphate-based active material. The first electrode layer 120 can include a lithium-based first active material, and the second electrode layer 125 can include a nickel-based second active material. Other combinations of active materials are possible.

The second active material can comprise 90-99.5% by weight of the second solid content or the second electrode layer 125. For example, the second active material can be 94-97% by weight of the second solid content or the second electrode layer 125. The second active material can be less than 90% or more than 99.5% by weight of the second electrode layer 125. The second electrode layer 125 can include a loading level of approximately (e.g., ±25%) 0.1-35 mg/cm² with the active material comprising 90-99.5% by weight of the first solid content or the first electrode layer 120. For example, the electrode 100 can achieve a loading level of 15-25 mg/cm² for a single-sided electrode 100, 25-50 mg/cm² for a double sided electrode 100, or greater than 50 mg/cm². The first electrode layer 120 can include a loading level of approximately (e.g., ±25%) 10-35 mg/cm² with the active material comprising 90-99.5% by weight of the first solid content or the first electrode layer 120. The first electrode layer 120 can include some other loading level with the active material comprising 90-99.5% by weight of the first solid content or the first electrode layer 120.

The electrode 100 can include the second electrode layer 125 including a second applied viscosity. For example, the second electrode layer 125 can include a second applied viscosity as the second electrode layer 125 is applied to the first electrode layer 120. As discussed below with reference to FIG. 4, among others, the second electrode layer 125 can be applied to the first electrode layer 120 via a slot die coating system or device. For example, a slot die coating system or device can apply a slurry (e.g., a semi-liquid mixture containing solid particles) to the first electrode layer 120 (which itself can be applied to the current collector material 105 as a slurry or semi-liquid mixture). The slurry can be a semi-liquid mixture as it is applied to the first electrode layer 120, but can later solidify to form a solid or semi-solid electrode layer. For example, the second electrode layer 125 can be applied to the first electrode layer 120 in an uncured or semi-liquid form. The second electrode layer 125 can be cured (e.g., heated, dried, or otherwise cured) to form a solid or semi-solid electrode layer after the second electrode layer 125 is applied to the first electrode layer 120. The electrode 100 can be used within a battery cell, battery module, or battery pack with the second electrode layer 125 in a cured state.

The second electrode layer 125 can include a second applied viscosity with the second electrode layer 125 in a slurry (e.g., semi-liquid) form. For example, the second electrode layer 125 can be applied to the current collector material 105 in an uncured, semi-liquid state with the second electrode layer 125 having the second applied viscosity. The second electrode layer 125 can thereafter be cured to form a solid or semi-solid electrode layer. The second electrode layer 125 can include the second applied viscosity as the second electrode layer 125 is applied to the first electrode layer 120 by the slot die coating system or device. The second applied viscosity of the first electrode layer 120 can be between 1,000 and 7,000 centipoise, less than 7,000 centipoise, or less than 1,000 centipoise.

The electrode 100 can include the first applied viscosity of the first electrode layer 120 being greater than the second applied viscosity of the second electrode layer 125. For example, the first electrode layer 120 can be applied to the first side 110 of the current collector material 105 can include a first applied viscosity of 7,000 centipoise or greater than 7,000 centipoise and the second electrode layer 125 applied to the first electrode layer 120 can include a second applied viscosity of 1,000-7,000 centipoise. The second solid content of the second electrode layer 125 can cause the second electrode layer 125 to be semi-resistant to flow as the second electrode layer 125 is applied to the first electrode layer 120 by a slot die coating device or system, but not as resistant to flow as the first electrode layer 120 as the first electrode layer 120 is applied to the current collector material 105. For example, the second electrode layer 125 can include the second applied viscosity of the slurry before coating that is less than the first applied viscosity of the slurry before coating because the first solid content can be composed of a relatively high percentage of solid particulate (e.g., 30-70% solid content or greater) as compared to the lower percentage of solid particulate (e.g., 10-50%) of the second solid content. The second electrode layer 125 can include the second applied viscosity of the slurry before coating that is less than the first applied viscosity of the slurry before coating because the first solid content can be composed of solid particulate having various particle sizes from 30 nm to 50 μm with different amount of solvent (e.g., NMP solvent or some other solvent).

The second electrode layer 125 can flatten at a quicker rate than the first electrode layer 120 with the second applied viscosity being less than the first applied viscosity. For example, the first electrode layer 120 can be applied to the current collector material 105 and can flatten to (e.g., spread out over, close voids between the first electrode layer 120 and the first side 110 of) the current collector material 105 at a first rate. The second electrode layer 125 can be applied to the first electrode layer 120 and can flatten to (e.g., spread out over, close voids between the second electrode layer 125 and) the first electrode layer 120 at a second rate. The second rate can be faster than the first rate. The second electrode layer 125 can achieve a surface morphology that is more uniform than a surface morphology of the first electrode layer 120 with the second applied viscosity being less than the first applied viscosity.

The electrode 100 can include the second electrode layer 125 including a second porosity. For example, the electrode 100 can include the second electrode layer 125 including the second porosity with the second electrode layer 125 in a cured state. The second electrode layer 125 can be porous or semi-porous with the second electrode layer 125 in a solid or semi-solid state (e.g., after a slurry or semi-liquid second electrode layer 125 has been cured). For example, voids (e.g., openings, gaps, space) can exist between solid particles of the cured second electrode layer 125. The second solid content of the second electrode layer 125 can include solid particles of various sizes from 30 nm to 50 μm. The second solid content can include solid particles of various shapes (e.g., spherical, irregular, or other shape). Because the solid particles of the second solid content can have varying sizes or shapes, the voids can exist between adjacent solid particles. The second porosity can be representative of the percentage of void space within the second electrode layer 125 with the second electrode layer 125 in a cured state. For example, a cross-section of the second electrode layer 125 can reveal a second porosity including at least 25% or less than 45% of the cross-sectional area of the second electrode layer 125 being void space. The second electrode layer 125 can include a second porosity having a value between 0.28-0.35 on a scale of 0 to 1. For example, the second electrode layer 125 can include the second porosity having a porosity value of approximately (e.g., ±15%) 0.28. The second porosity can be some other representation of the void space of the second electrode layer 125 (e.g. volumetric measurement of void space). The second porosity of the second electrode layer 125 can be less than the first porosity of the first electrode layer 120. For example, the second electrode layer 125 can include a smaller percentage of void space than the first electrode layer 120 with the second electrode layer 125 including solid particulate of a smaller size than the first electrode layer 120.

The electrode 100 can include the second electrode layer 125 including a surface morphology that is more uniform than a surface morphology of the first electrode layer 120. For example, the second electrode layer 125 can include the second solid content including solid particulate that is smaller (e.g., smaller cross-sectional area, smaller volume) than solid particulate of the first solid content of the first electrode layer 120. The smaller solid particulate of the second electrode layer 125 can facilitate a flattening of the second electrode layer 125 to create a uniform or substantially uniform (e.g., ±25% surface variation) surface of the second electrode layer 125 when the second electrode layer 125 is applied to another object (e.g., the first electrode layer 120). The surface morphology of the second electrode layer 125 can be more uniform, can exhibit fewer surface irregularities, or can exhibit surface irregularities of a lesser magnitude than the first electrode layer 120 with the second electrode layer 125 including smaller solid particulate than the first electrode layer 120. For example, the relatively smaller solid particulate of the second electrode layer 125 can cause surface irregularities of a smaller dimension than surface irregularities caused by the relatively larger solid particulate of the first electrode layer 120, thereby resulting in a surface morphology of the second electrode layer 125 that is more uniform than a surface morphology of the first electrode layer 120. The second electrode layer 125 can include a second applied viscosity that is lesser than the first applied viscosity of the first electrode layer 120 to create a surface morphology of the second electrode layer 125 that is more uniform than a surface morphology of the first electrode layer 120. For example, the second applied viscosity being relatively low can allow the second electrode layer 125 to be applied evenly (e.g., spread, flatten, fill surface voids or impressions) to the first electrode layer 120 to create a surface morphology of the second electrode layer 125 that is more uniform than a surface morphology of the first electrode layer 120.

The electrode 100 can include the second electrode layer 125 including a second thickness 210. For example, the second thickness 210 of the second electrode layer 125 can be a thickness of the second electrode layer 125 after the second electrode layer 125 is applied to the first electrode layer 120. The first thickness 205 of the first electrode layer 120 can be greater than the second thickness 210 of the second electrode layer 125. For example, the second thickness 210 of the second electrode layer 125 can be approximately (e.g., ±25%) 100 μm (micrometers), less than 100 μm, or greater than 100 μm, while the first thickness 205 can be approximately (e.g., ±25%) 150 μm, between 100 μm and 150 μm, or greater than 150 μm. The second thickness 210 can be 25% of the first thickness 205, between 25% and 95% of the first thickness 205, or less than 25% of the first thickness 205.

The electrode 100 can include the first electrode layer 120 including a first energy density that is greater than a second energy density of the second electrode layer 125. For example, the first electrode layer 120 can include a first applied viscosity of a first slurry before coating, a first solid content, a first porosity, or a first surface morphology to facilitate the first energy density of the first electrode layer 120. The second electrode layer 125 can include the second applied viscosity of a second slurry before coating, the second solid content, the second porosity, or the second surface morphology to facilitate the second energy density of the second electrode layer 125. The first energy density of the first electrode layer 120 can be greater than the second energy density of the second electrode layer 125 with the first solid content that is greater than a second solid content of the second electrode layer 125. For example, the first solid content can include a greater proportion of solid particulate than the second solid content. The first solid content can include solid particulate of a greater size or dimension than solid particulate of the second solid content. The first electrode layer 120 can include a first viscosity of the first slurry before coating that is greater than the second viscosity of the second slurry before coating of the second electrode layer 125 because the first solid content can include larger solid particulate. The greater first solid content can cause the first electrode layer 120 to include a larger proportion of first active material than a proportion of second active material of the second electrode layer 125. The increased proportion of first active material can cause the first electrode layer 120 to include a greater energy density than the second electrode layer 125.

The electrode 100 can include the second electrode layer 125 including a second power density that is greater than a first power density of the first electrode layer 120. For example, the second electrode layer 125 can include a second applied viscosity of the second slurry before coating, a second solid content, a second porosity, or a second surface morphology to facilitate the second power density of the second electrode layer 125. The second power density can be greater than a first power density of the first electrode layer 120 with the second applied viscosity of the second slurry before coating being less than the first applied viscosity of the first slurry before coating. For example, the second applied viscosity of the second slurry before coating of the second electrode layer 125 can be less than the first applied viscosity of the first slurry before coating of the first electrode layer 120 because the second electrode layer 125 can include a second solid content including smaller solid particulate than the solid particulate of the first solid content. The smaller solid particulate of the second electrode layer 125 can result in a diffusion length of the second electrode layer 125 that is shorter than a diffusion length of the first electrode layer 120. For example, the second electrode layer 125 can include the second power density that is greater than the first power density of the first electrode layer 120 with the diffusion length of the second electrode layer 125 being smaller than the diffusion length of the first electrode layer 120. The second electrode layer 125 can include a second porosity that is less than the first porosity, which can cause the diffusion length of the second electrode layer 125 to be smaller than a diffusion length of the first electrode layer 120.

Battery electrodes can be optimized for energy density (e.g., range of an electric vehicle, runtime of a battery-operated device, or battery life of a consumer electronic device). When optimized for energy density, the battery electrode can include a reduced power density. For example, to increase an energy density of a battery electrode, larger solid particulate can be used to create a thicker electrode. However, the larger solid particulate can increase a diffusion length of the battery electrode, thereby reducing the power density of the electrode. To the contrary, to optimize a battery electrode for power density (e.g., to increase power available to an electric vehicle or to decrease the charge time of a battery cell), smaller solid particulate can be used to create a shorter diffusion length. However, the smaller solid particulate can reduce a solid content of the slurry mix (e.g., such that the slurry mix includes a larger volume or quantity of NMP solvent) and packing density, thereby reducing the energy density of the electrode. For another example, high loading (e.g., high coating weight or high solid content) can increase energy density by reducing total number of stacked electrode layers in a battery cell housing having a fixed cell size, but high loading can decrease power density and rate capability affected by Li-ion diffusion limitation inside thicker coating layer. Accordingly, optimization for energy density can occur at the expense of power density, and optimization for power density can occur at the expense of energy density. Consideration of electrochemical properties of active material particulates and the effect of high loading and thickness of coating layers, such as by implementing multiple electrode layers of varying applied slurry viscosities, solid content, layer thicknesses, or parameters can overcome this trade-off.

The electrode 100 can include a first performance characteristic of the first electrode layer 120 and a second performance characteristic of the second electrode layer 125. The electrode can include the first performance characteristic of the first electrode layer 120 to bolster an energy density of the electrode 100. For example, the first energy density of the first electrode layer 120 can be greater than the second energy density of the second electrode layer 125. The first performance characteristic of the first electrode layer 120 can be the first thickness 205 that is greater than the second thickness 210 of the second electrode layer 125. The first performance characteristic of the first electrode layer 120 can be the first solid content having solid particulate of a first size that is larger than a second size of solid particulate of the second solid content of the second electrode layer 125. The first performance characteristic of the first electrode layer 120 can cause the first electrode layer 120 to have the first energy density that is greater than the second energy density of the second electrode layer 125 but a first power density that is less than the second power density of the second electrode layer 125.

The electrode 100 can include the second performance characteristic of the second electrode layer 125 to bolster a power density of the electrode 100. For example, the second power density of the second electrode layer 125 can be greater than the first power density of the first electrode layer 120. The second performance characteristic of the second electrode layer 125 can be the second thickness 210 being less than the first thickness 205 of the first electrode layer 120. The second performance characteristic of the second electrode layer 125 can be the second solid content having solid particulate of a second size that is smaller than a first size of solid particulate of the first solid content of the first electrode layer 120. The second performance characteristic of the second electrode layer 125 can cause the second electrode layer 125 to have the second power density that is greater than the first electrode layer 120 but a second power density that is less than the first power density of the first electrode layer 120.

The electrode 100 can include the first electrode layer 120 including the first performance characteristic to bolster an energy density of the electrode 100, and the second electrode layer 125 including the second performance characteristic to bolster a power density of the electrode 100. For example, the electrode 100 can include the first electrode layer 120 having an energy density greater than the second electrode layer 125. The electrode can include the second electrode layer 125 including the second power density that is greater than the first power density of the first electrode layer 120. Accordingly, the electrode 100 can include an electrode layer (e.g., the first electrode layer 120) that includes the first performance characteristic to improve the energy density of the electrode 100 and another electrode layer (e.g., the second electrode layer 125) that includes the second performance characteristic to improve the power density of the electrode 100. The electrode 100 can thus include multiple electrode layers, with at least one electrode layer optimized for energy density performance characteristics and at least another electrode layer optimized for power density performance characteristics.

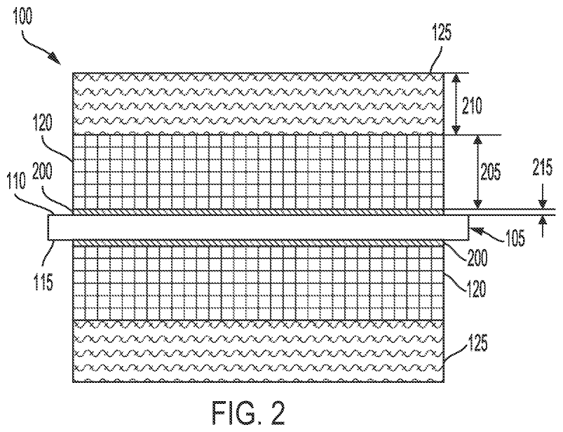

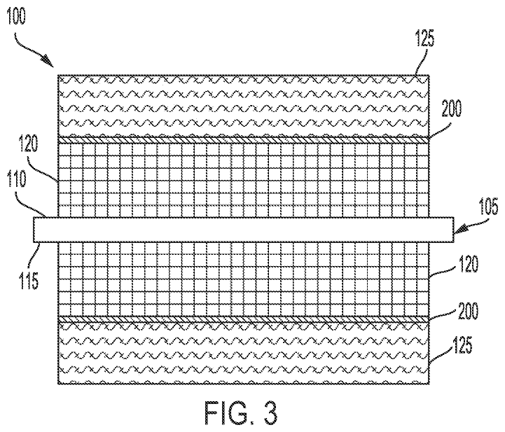

The electrode 100 can include at least one buffer layer. For example, the electrode 100 can include a buffer layer 200, as depicted in FIGS. 2 and 3, among others. The buffer layer can be an intervening layer positioned between an electrode layer (e.g., the first electrode layer 120) and the current collector material 105 or between two adjacent electrode layers (e.g., the first electrode layer 120 and the second electrode layer 125). The electrode 100 can include multiple buffer layers 200. For example, the electrode 100 can include one buffer layer 200 positioned on either side 110, 115 of the current collector material 105. The electrode 100 can include multiple buffer layers 200 on each side 110, 115 of the current collector material 105.

The electrode 100 can include the buffer layer 200 including a material composition. For example, the material composition of the buffer layer 200 can include a binder material. For example, the binder material of the buffer layer 200 can be or include polyvinylidenefluoride (PVDF), polyvinylpyrrolidone (PVP), styrene-butadiene or styrene-butadiene rubber (SBR), polytetrafluoroethylene (PTFE), carboxymethylcellulose (CMC), or some other binder material. The binder material of the buffer layer 200 can be the same as or different than a binder material of the first electrode layer 120 or the second electrode layer 125. The material composition of the buffer layer 200 can include a conductive material (e.g., carbon, granule, graphene, CNT, a conductive polymer, or other conductive material). For example, the conductive material of the buffer layer 200 can be or include carbon black (granule), CNT (carbon nanotubes), graphene, or some other conductive material. The conductive material of the buffer layer 200 can be the same as or different than a binder material of the first electrode layer 120 or the second electrode layer 125. The material composition of the buffer layer 200 can include an active material. For example, the active material of the buffer layer 200 can be or include a nickel-based active material or a lithium iron phosphate-based active material. The buffer layer 200 be without an active material. For example, the buffer layer 200 can include a binder material or a conductive material, but no active material. The buffer layer 200 can include a third solid content comprising a binder material and a conductive material. The buffer layer 200 can be applied to another substance (e.g., a current collector material 105 or an electrode layer) with the buffer layer in a slurry (e.g., semi-liquid) form. For example, the buffer layer 200 can be applied to another substance with the buffer layer 200 in an uncured state. The buffer layer 200 can be subsequently cured such that the buffer layer 200 becomes a solid or semi-solid material. For example, the buffer layer 200 can be cured by heat (e.g., heating the buffer layer in an oven) or via some other curing means.

The electrode 100 can include the buffer layer 200 positioned between the current collector material 105 and the first electrode layer 120. For example, the buffer layer 200 can be positioned between the first side 110 of the current collector material 105 and the first electrode layer 120, as depicted in FIG. 2, among others. The first electrode layer 120 can be applied to the first side 110 of the current collector material 105 with the buffer layer 200 disposed between the current collector material 105 and the first electrode layer 120. The buffer material 200 can include a binder material and a conductive material, but no active material. The electrode 100 can include the buffer layer 200 positioned between the first side 110 of the current collector material 105 and the upper first electrode layer 120 and also between the second side 115 of the current collector material 120 and the lower first electrode layer 120. For example, the buffer layer 200 can be positioned between the first electrode layer 120 and the current collector material 105 with a first electrode layer applied to both the first side 110 and the second side 115 of the current collector material. The buffer layer 200 can be applied to the current collector material 105 with the buffer layer 200 in an uncured state. For example, the buffer layer 200 can be applied as a slurry (e.g., a semi-liquid material) to the current collector material 105, and the first electrode layer 120 can be applied to the buffer layer 200 as a slurry. The buffer layer 200, the first electrode layer 120, and any other layers (e.g., the second electrode layer 125, a third electrode layer) can subsequently be cured such that the buffer layer 200, the first electrode layer 120, and any other electrode layers take a solid or semi-solid form.

The electrode 100 can include the buffer layer 200 positioned between the first electrode layer 120 and the second electrode layer 125. For example, the electrode 100 can include the buffer layer 200 disposed between the first electrode layer 120 and the second electrode layer 125 with the second electrode layer 125 applied to the first electrode layer 120, as depicted in FIG. 3, among others. The electrode 100 can include the buffer layer 200 positioned between the upper first electrode layer 120 and the upper second electrode layer 125 and between the lower first electrode layer 120 and the lower second electrode layer 125. For example, the buffer layer 200 can be positioned between the first electrode layer 120 and the second electrode layer 125 with a first electrode layer 120 applied to both the first side 110 and the second side 115 of the current collector material 105. The buffer layer 200 can be applied to the first electrode layer 120 with the first electrode layer 120 in an uncured state. For example, the first electrode layer 120 can be applied as a slurry (e.g., a semi-liquid material) to the current collector material 105, and the buffer layer 200 can be applied to the first electrode layer 120 as a slurry. The second electrode layer 125 can be applied to the buffer layer 200 with the buffer layer 200 in an uncured state. The first electrode layer 120, the buffer layer 200, and the second electrode layer 125 can subsequently be cured such that the first electrode layer 120, the buffer layer 200, and the second electrode layer 125 take a solid or semi-solid form.

The electrode 100 can include the buffer layer 200 positioned between the first electrode layer 120 and the current collector material 105 to adhere the first electrode layer 120 to the current collector material 105. For example, the buffer layer 200 can be positioned between the first electrode layer 120 and the first side 110 of the current collector material 105 or between the first electrode layer 120 and the second side 115 of the current collector material 105. The buffer layer 200 can include a binder material, such as polyvinylidenefluoride (PVDF), polyvinylpyrrolidone (PVP), styrene-butadiene or styrene-butadiene rubber (SBR), polytetrafluoroethylene (PTFE), carboxymethylcellulose (CMC), or some other binder material, to bind the first electrode layer 120 to the current collector material 105. For example, the binder material of the buffer layer 200 can reduce a risk of the first electrode layer 120 delaminating (e.g., separating) from the current collector material 105 to which it is applied. The material composition of the buffer layer 200 can include a proportion (e.g., a percentage by weight) of binder material being greater than or approximately equal to (e.g., ±25%) a proportion of binder material of the first electrode layer 120 or the second electrode layer 125. The material composition of the buffer layer 200 can include a molecular weight of a binder material being greater than or approximately equal to (e.g., ±25%) a molecular weight of the first binder material of the first electrode layer 120 and the second binder material of the second electrode layer 125. The increased proportion or molecular weight of the binder material of the buffer layer 200 can facilitate an adhesion of the first electrode layer 120 to the current collector material 105 or facilitate an adhesion of the second electrode layer 125 to the first electrode layer 120. Increased conductive material (e.g., carbon) contents in the buffer layer can help improve the overall electronic conductivity but also help adhesion of the first and second electrode layers. For example, if there is only one electrode layer (e.g., the first electrode layer 120) of high loading (e.g., high solid content) coated directly (e.g., without an intervening buffer layer) on the current collector material 105, an interface between a surface of the current collector material 105 and the electrode layer is only held by the binder materials that are exposed at the metal surface of the current collector material 105. Since a metal hardness is much higher than carbon, the metal surface of the current collector material 105 will not deform during a calendaring operation (e.g., compression operation) of the electrode layer with the electrode layer applied to the current collector material 105. A buffer layer can change the interfacial morphology when a compressive force is being applied during a calendaring operation to improve adhesion of the electrode layer to the current collector material 105. A buffer layer between the electrode layer and the current collector material 105 can cause more binder materials to be exposed between the electrode layer and the buffer layer, which can lead to better electrode adhesion, as to compared to an electrode layer applied directly onto a current collector material 105.

The buffer layer 200 can prevent a dissolution of an active material of an electrode layer. For example, the buffer layer 200 can reduce or substantially prevent (e.g., prevent 50% or more of) a dissolution of an active material of the electrode 100. Active materials, such as cathode active materials, can experience dissolution, degradation, or transfer of ions (e.g., transfer metal ions) during use of an electrode. For example, a transfer metal ion of a cathode active material can dissolve from an electrode layer and migrate (e.g., move, transition) to another layer, such as a current collector material, electrolyte layer (e.g., separator layer) disposed between adjacent electrode layers, or two another electrode layer (e.g., an anode electrode). This phenomena can occur during high voltage operation of a battery cell or when operating a battery cell at an elevated temperature, for example. The buffer layer 200 can act as a physical barrier between a cathode active material (e.g., the first electrode layer 120) and a current collector material 105 to prevent the movement of ions from a cathode active material (e.g., the first active material) to another layer. For example, the binder material and conductive material of the buffer layer 200 can impede a movement of transition metal ions from the first active material of the first electrode layer 120 to the current collector material 105. The buffer layer 200 can be positioned elsewhere with respect to the first electrode layer 120, the current collector material 105, or the second electrode layer 125 to reduce or substantially prevent (e.g., prevent 50% or more of) a dissolution of an active material of the electrode 100. For example, the buffer layer 200 can be applied to the second electrode layer 125 to prevent movement of transition metal ions from the second active material of the second electrode layer 125 to another layer (e.g., the first electrode layer 120), to another electrode (e.g., an adjacent electrode 100 within a battery cell), or to an electrolyte material positioned between the electrode 100 and another electrode or other material.

The electrode 100 can include at least one buffer layer 200 to conduct ions between the first electrode layer 120 and the second electrode layer 125. For example, the buffer layer 200 can conduct ions, such as negatively charged particles (e.g., electrons), positively charged particles (e.g., protons), cations, anions, negatively charged molecules or atoms, positively charged molecules or atoms, or some other ions. The buffer layer 200 can include a conductive material, such as carbon black (granule), CNT (carbon nanotubes), graphene, a conductive polymer, or some other conductive material, to conduct ions from the first electrode layer 120 to the second electrode layer 125 or from the second electrode layer 125 to the first electrode layer 120. The conductive material of the buffer layer 200 can conduct ions from one electrode layer (e.g., the first electrode layer 120) to another electrode layer (e.g., the second electrode layer 125) or from an electrode layer (e.g., the first electrode layer 120) to the current collector material 105. The buffer layer 200 can include a material composition including a proportion (e.g., percentage by weight) of a conductive material that is greater than or approximately equal to (e.g., ±25%) a proportion of conductive material of the first electrode layer 120 or the second electrode layer 125. The buffer layer 200 can include a material composition including a molecular weight of a conductive material that is greater than or approximately equal to (e.g., ±25%) a molecular weight of the first conductive material of the first electrode layer 120 or the second conductive material of the second electrode layer 125. The buffer layer 200 can include a conductivity that is greater than a conductivity of the first electrode layer 120, the second electrode layer 125, or the current collector material 105.

The electrode 100 can include the buffer layer 200 including a third thickness 215. The third thickness 215 of the buffer layer 200 can be less than the first thickness 205 of the first electrode layer 120. The third thickness 215 of the buffer layer 200 can be less than the second thickness 210 of the second electrode layer 125. For example, the third thickness 215 can be less than 10 micrometers (μm), less than 25 μm, less than 50 μm, or some other thickness. The third thickness 215 can be approximately 10% as thick as the first thickness 205 or the second thickness 210. For example, the first electrode layer 120 or the second electrode layer 125 can be thicker than the buffer layer 200 by an order of magnitude (e.g., twice as thick, five times as thick, twenty times as thick, or some other order of magnitude). Accordingly, the buffer layer 200 can be a thin layer positioned between the first electrode layer 120 and the current collector material 105 or between the first electrode layer 120 and the second electrode layer 125. The buffer layer 200 can be relatively thin because the buffer layer 200 can be without an active material and can therefore have the third solid content that is lesser than the first solid content of the first electrode layer 120 or the second solid content of the second electrode layer 125.

FIG. 4, among others, depicts a cross-sectional view of a slot die coating system 400. The system 400 can apply an electrode layer to a current collector material. For example, the slot die coating system 400 can apply the first electrode layer 120 to the current collector material 105. The slot die coating system 400 can apply the second electrode layer 125 to the first electrode layer. The slot die coating system 400 can include a first die 405, a second die 410, a third die 415, and a fourth die 420. For example, the slot die coating system 400 can include the first die 405 and the second die 410 defining a first cavity 435 and a first coating point 425. The first cavity 435 can receive a first slurry 430 (e.g., semi-liquid material). The first slurry 430 can be the first electrode layer 120 with the first electrode layer 120 in slurry form, for example. The slot die coating system 400 can include the third die 415 and the fourth die 420 defining a second cavity 450 and a second coating point 440. The second cavity 450 can receive a second slurry 445 (e.g., semi-liquid material). The second slurry 445 can be the second electrode layer 125 with the second electrode layer 125 in slurry form, for example. The slot die coating system 400 can include the second die 410 and the third die 415 defining a third cavity 465 and a third coating point 455. The third cavity 465 can receive a third slurry 460 (e.g., semi-liquid material). The third slurry 460 can be the buffer layer 200 with the buffer layer 200 in slurry form, for example.

The coating points 425, 440, 455 can each be a space, volume, void, gap, opening, or location at which a material (e.g., the slurry 430, the slurry 445, the slurry 460, or some other material) is applied to another material (e.g., the current collector material 105, the first electrode layer 120, the buffer layer 200, or some other material). For example, the first coating point 425 can be a gap between the first die 405 and the second die 410. The second coating point 440 can be a gap between the third die 415 and the fourth die 420. The third coating point 455 can be a gap between the second die 410 and the third die 415. For example, the first slurry 430 can exit the slot die coating system 400 via the first coating point 425 to apply the first slurry 430 to the current collector material 105. The first coating point 425, the second coating point 440, and the third coating point 455 can extend for a length (e.g., into the page as depicted in FIG. 4) such that the slot die coating system 400 can apply material along the length. For example, the first slurry 430 can be applied to the current collector material 105 via the first coating point 425 such that the first electrode layer 120 can have a width approximately equal to (e.g., ±95%) a length in which the first coating point 425 extends. The first electrode layer 120, the second electrode layer 125, and the buffer layer 200 can form a generally rectangular shape with respect to the current collector material 105 after it is applied to the current collector material 105 via the slot die coating system 400.

The system 400 can include at least one slurry pump to cause the slurry 430, the slurry 445, or the slurry 460 to exit the slot die coating system 400 at a particular volumetric rate. For example, the system 400 can include a first slurry pump to cause the first slurry 430 to exit the first coating point 425 to apply the first slurry 430 to the current collector material 105. The first slurry pump can cause the first slurry 430 to exit the first cavity 435 via the first coating point 425 to form the first electrode layer 120. The system 400 can include a second slurry pump to cause the second slurry 445 to exit the second coating point 440 to apply the second slurry 445 to the current first electrode layer 120. The second slurry pump can cause the second slurry 445 to exit the second cavity 450 via the second coating point 440 to form the second electrode layer 125. The system 400 can include a third slurry pump to cause the third slurry 460 to exit the third coating point 455 to apply the third slurry 460 to the current collector material 105 or to the first electrode layer 120. For example, the third slurry pump can cause the third slurry 460 to exit the third cavity 465 via the third coating point 455 to form the buffer layer 200. Although FIG. 4 depicts the buffer layer 200 as applied to the first electrode layer 120 and therefore positioned between the first electrode layer 120 and the second electrode layer 125, it should be understood that the buffer layer 200 can be positioned between the current collector material 105 and the first electrode layer 120 or atop the second electrode layer 125. The one or more slurry pumps can be adjustable to adjust a volumetric flow rate of a slurry material (e.g., the first slurry 430 from the cavity 435 of the slot die coating system 400.

The current collector material 105 can move relative to the slot die coating system 400. For example, the current collector material 105 can move in a first direction 470, while the slot die coating system 400 remains stationary or fixed. The current collector material 105 can remain stationary while the slot die coating system 400 moves in a direction opposite the first direction 470. For example, the slot die coating system 400 can be positioned adjacent the current collector material 105 such that the first coating point 425, the second coating point 440, and the third coating point 455 are spaced apart from the first side 110 of the current collector material 105, where the slot die coating system 400 can translate relative to the current collector material 105 while the a distance is substantially maintained (e.g., ±25% variance) between the current collector material 105 and the first coating point 425, the second coating point 440, and the third coating point 455. The current collector material 105 can move within a plane as the slot die coating system 400 applies the first electrode layer 120 to the current collector material 105. For example, the current collector material 105 can be substantially flat (e.g., ±15% unevenness or variance). The current collector material 105 can move in the first direction 470 while the current collector material is substantially flat such that a distance between the current collector material 105 and the coating points 425, 440, and 455 remains substantially constant (e.g., ±15% variance). The current collector material 105 can move in a substantially flat orientation with the current collector material 105 against a conveyor surface (e.g., a conveyor substrate, conveyor belt, or similar conveyance device). The current collector material 105 can move in a substantially flat orientation with the current collector material 105 engaged with at least one web handling device. For example, the web handling device can be a roller, an idler, a wheel, a rotatable tensioner device, or some other device that can pull or move the current collector material 105 in the first direction 470. The web handling device can applying a tension to the current collector material 105 such that the current collector material 105 moves in a flat orientation in the first direction 470. The web handing device can apply a tension to the current collector material to ensure that the current collector material 105 is substantially (e.g., ±90%) free from wrinkles or slack.

The current collector material 105 can be at least partially curved or arced as the slot die coating system 400 applies a material (e.g., the first slurry 430) to another material (e.g., the current collector material 105). For example, the system 400 can include a roller against (e.g., adjacent to, along, while in contact with) which the current collector material 105 can move against. The roller can be a circular roller or some other shape. The roller can rotate in a second direction. The roller can include an outer surface that positioned near (e.g., proximate to, close to, within a predetermined distance of) one or more of the coating points 425, 440, 455 of the slot die coating system 400. The current collector material 105 can move against (e.g., adjacent to, along, while in contact with) the outer surface of the roller. The current collector material 105 can be spaced apart from the coating points 425, 440, 455 of the slot die coating system 400 with the current collector material 105 moving against the roller. The current collector material 105 can be spaced apart from the coating points 425, 440, 455 of the slot die coating system 400 by a distance with the current collector material 105 moving against the roller. The current collector material 105 can contact (e.g., ride against) an arcuate portion of the roller such that current collector material 105 converges towards the coating points 425, 440, 455 as it approaches the slot die coating system 400 or diverges from the coating points 425, 440, 455 as the current collector material 105 that has been coated (e.g., with the first slurry 430 to form the first electrode layer 120) moves away from the slot die coating system 400. The current collector material 105 can move in a direction that is substantially flat such that a direction in which the current collector material 105 approaches the slot die coating system 400 is substantially similar to (e.g., ±95% similar) to the direction in which the current collector moves away from the slot die coating system 400. For example, the current collector material 105 can contact the outer surface of the roller at a discrete point (e.g., not an arcuate portion) of the outer surface of the roller.

The slot die coating system 400 can include three dies (e.g., the first die 405, the second die 410, and the third die 415) and can define two cavities to apply two electrode layers. For example, the electrode 100 can include the first electrode layer 120 applied to the current collector material 105 and the second electrode layer 125 applied to the first electrode layer 120 with no buffer layer 200. In such instances, the slot die coating system 400 can include a first cavity (e.g., the first cavity 435) containing the first slurry 430 to apply the first electrode layer 120 and a second cavity (e.g., the second cavity 450) containing the second slurry 445 to apply the second electrode layer 125. In other examples, the slot die coating system 400 can include additional dies to define more than three cavities (e.g., four cavities, five cavities, more than five cavities) such that additional layers can be applied. For example, the electrode 100 can include a first buffer layer 200 disposed between the first electrode layer 120 and the current collector material and a second buffer layer 200 positioned between the first electrode layer 120 and the second electrode layer 125. The electrode 100 can include a third electrode layer or a buffer layer disposed between the second electrode layer 125 and the third electrode layer, for example. In various circumstances, the slot die coating system 400 can include more or fewer dies and cavities to facilitate the application of multiple layers (e.g., electrode layers, buffer layers, electrolyte layers, or other layers) to a current collector material or other material (e.g., to an electrode layer, to a buffer layer, to an electrolyte layer).

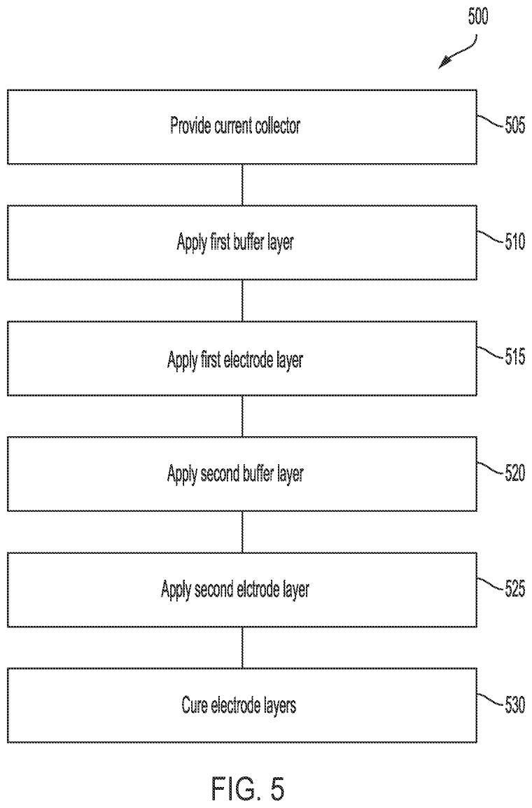

FIG. 5 is a flow chart of a method 500. The method 500 can be a method of producing or manufacturing an electrode, such as the electrode 100. For example, the method 500 can create the electrode 100 using the slot die coating system 400 as depicted in FIG. 4, among others. The method 500 can include one or more of ACTS 505-530. For example, one or more of ACTS 505-530 can be optional. One or more of ACTS 505-530 of the method 500 can be performed by the slot die coating system 400 or by some other system. The method 500 can include ACTS 505-530 performed in the order shown in FIG. 5 or in some other order.

The method 500 can include providing a current collector at ACT 505. For example, the method 500 can include providing the current collector material 105 at ACT 505. The current collector material 105 can be provided to the slot die coating system 400 so that the slot die coating system 400 can apply an electrode layer (e.g., the first electrode layer 120, the second electrode layer 125, or some other electrode layer) to the current collector material 105. The current collector material 105 can be a copper foil, aluminum foil, carbon-coated aluminum foil. The current collector material 105 can be provided proximate to (e.g., close to, near to, adjacent to, within a predetermined distance of) the one or more of the coating points 425, 440, 455 of the slot die coating system 400. The current collector material 105 can be provided to the slot die coating system 400 such that the current collector material 105 can move in a first direction 470 or can rotate around an arcuate portion of an outer surface of a roller as the roller rotates such that the current collector material 105 can move relative to the coating points 425, 440, 455 of the slot die coating system 400.

The method 500 can include applying a first buffer layer at ACT 510. For example, the method 500 can include applying a buffer layer 200 (e.g., a first buffer layer 200) to the first side 110 of the current collector material 105 at ACT 510. The first buffer layer 200 can be applied by the slot die coating system 400 to the first side 110 of the current collector material 105. For example, the first cavity 435 of the slot die coating system 400 can receive the first slurry 430. The first slurry 430 can be applied, via the slot die coating system 400, to the current collector material 105 to form the first buffer layer 200. For example, the first slurry 430 can include a binder material and a conductive material, but no active material. The first buffer layer 200 can be applied to the current collector material 105 such that the buffer layer 200 includes a first buffer layer thickness (e.g., the third thickness 215).

The method 500 can include applying a first electrode layer at ACT 515. For example, the method can include applying the first electrode layer 120 to the current collector material 105 at ACT 515. Applying the first electrode layer 120 to the current collector material 105 can include applying the first electrode layer 120 to the first buffer layer 200, where the first buffer layer 200 can be applied to the current collector material 105 at ACT 510. The third cavity 465 of the slot die coating system 400 can receive a third slurry 460. The third slurry 460 can be applied, via the slot die coating system 400, to the current collector material 105 or to the first buffer layer 200 applied at ACT 510 to form the first electrode layer 120. The third slurry 460, and thus the first electrode layer 120, can include a first binder material, a first conductive material, and a first active material. The first electrode layer 120 can include a first applied viscosity and a first solid content. The first electrode layer 120 can include a first thickness 205. The first thickness 205 can be greater than the first buffer layer thickness (e.g., the third thickness 215).

The method 500 can include applying a second buffer layer at ACT 520. For example, the method 500 can include applying a second buffer layer 200 to the first electrode layer 120 at ACT 520. The second buffer layer 200 can be applied by the slot die coating system 400 to the first electrode layer 120. For example, the second cavity 450 of the slot die coating system 400 can receive the second slurry 445. The second slurry 445 can be applied, via the slot die coating system 400, to the first electrode layer 120 to form the second buffer layer 200. For example, the second slurry 445 can include a binder material and a conductive material, but no active material. The second buffer layer 200 can be applied to the first electrode layer 120 such that the second buffer layer 200 includes a second buffer layer thickness (e.g., the third thickness 215 or some other thickness). The second buffer layer 200 can include a material composition (e.g., a binder material or a conductive material) that is the same as or different than the binder layer 200 applied at ACT 510. The second buffer layer 200 can include the second buffer layer thickness that is the same as or different than the first buffer layer thickness. The second buffer layer thickness can be less than the first thickness 205, for example.

The method 500 can include applying a second electrode layer at ACT 525. For example, the method can include applying the second electrode layer 125 to the first electrode layer 120 at ACT 525. Applying the second electrode layer 125 to the first electrode layer 120 can include applying the second electrode layer 125 to the second buffer layer 200, where the second buffer layer 200 can be applied to the first electrode layer 120 at ACT 520. A fourth cavity of the slot die coating system 400 can receive a fourth slurry. The fourth slurry can be applied, via the slot die coating system 400, to the first electrode layer 120 or to the second buffer layer 200 applied at ACT 520 to form the second electrode layer 125. The fourth slurry, and thus the second electrode layer 125, can include a second binder material, a second conductive material, and a second active material. The second electrode layer 125 can include a second applied viscosity and a second solid content. The second applied viscosity can be less than the first applied viscosity of the first electrode layer 120. The second solid content can comprise a smaller proportion of the second electrode layer 125 than the first solid content comprises a proportion of the first electrode layer 120. The second electrode layer 125 can include a second thickness 210. The second thickness 210 can be greater than the first buffer layer thickness (e.g., the third thickness 215) or the second buffer layer thickness. The second thickness 210 can be less than the first thickness 205 of the first electrode layer 120.

The method 500 can include curing the electrode layers at ACT 530. For example, method 500 can include curing the first electrode layer 120 and the second electrode layer 125 at ACT 530. The first electrode layer 120 and the second electrode layer 125 can be applied by the slot die coating system 400 with the first electrode layer and the second electrode layer 125 in an uncured (e.g., slurry, semi-liquid) form. The first electrode layer 120 and the second electrode layer 125 can be cured to form a solid or semi-solid layer. For example, the first electrode layer 120 and the second electrode layer 125 can be heated (e.g., in an oven or under proximate a heating element) to cure the first electrode layer 120 and the second electrode layer 125. The first electrode layer 120 and the second electrode layer 125 can be solid or semi-solid with the first electrode layer 120 an the second electrode layer 125 in a cured state. The slot die coating system 400 can include or can be operatively coupled with a heating element (e.g., an oven) to cure the first electrode layer 120 and the second electrode layer. For example, the current collector material 105 can move in the first direction 470 as the first electrode layer 120 and the second electrode layer 125 are applied via the slot die coating system 400. The current collector material 105 can continue in the first direction 470 or in some other direction beyond the coating points 425, 440, 455 of the slot die coating system 400 to the heating element. For example, the current collector material 105, the applied first electrode layer 120, the applied second electrode layer 125, and any applied buffer layers 200 can move from the slot die coating system 400 to a heating element with the applied first electrode layer 120, the applied second electrode layer 125, and any applied buffer layers 200 in an uncured state. The current collector material 105, the applied first electrode layer 120, the applied second electrode layer 125, and any applied buffer layers 200 can be cured by the heating element such that the applied first electrode layer 120, the applied second electrode layer 125, and any applied buffer layers 200 become cured (e.g., dry, solidified, semi-solidified, or otherwise cured).

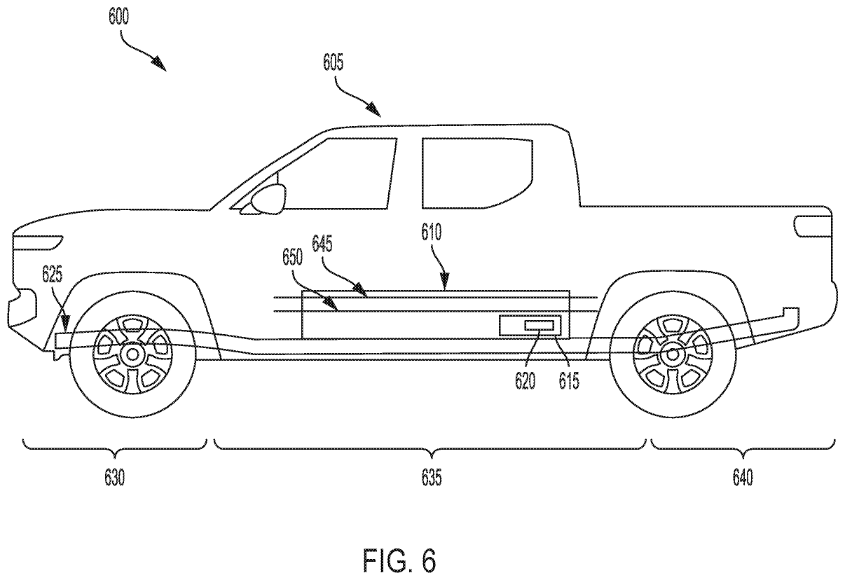

FIG. 6 depicts an example cross-sectional view 600 of an electric vehicle 605 installed with at least one battery pack 610. Electric vehicles 605 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 610 can also be used as an energy storage system to power a building, such as a residential home or commercial building. Electric vehicles 605 can be fully electric or partially electric (e.g., plug-in hybrid) and further, electric vehicles 605 can be fully autonomous, partially autonomous, or unmanned. Electric vehicles 605 can also be human operated or non-autonomous. Electric vehicles 605 such as electric trucks or automobiles can include on-board battery packs 610, batteries 615 or battery modules 615, or battery cells 620 to power the electric vehicles. The electric vehicle 605 can include a chassis 625 (e.g., a frame, internal frame, or support structure). The chassis 625 can support various components of the electric vehicle 605. The chassis 625 can span a front portion 630 (e.g., a hood or bonnet portion), a body portion 635, and a rear portion 640 (e.g., a trunk, payload, or boot portion) of the electric vehicle 605. The battery pack 610 can be installed or placed within the electric vehicle 605. For example, the battery pack 610 can be installed on the chassis 625 of the electric vehicle 605 within one or more of the front portion 630, the body portion 635, or the rear portion 640. The battery pack 610 can include or connect with at least one busbar, e.g., a current collector element. For example, the first busbar 645 and the second busbar 650 can include electrically conductive material to connect or otherwise electrically couple the battery 615, the battery modules 615, or the battery cells 620 with other electrical components of the electric vehicle 605 to provide electrical power to various systems or components of the electric vehicle 605.

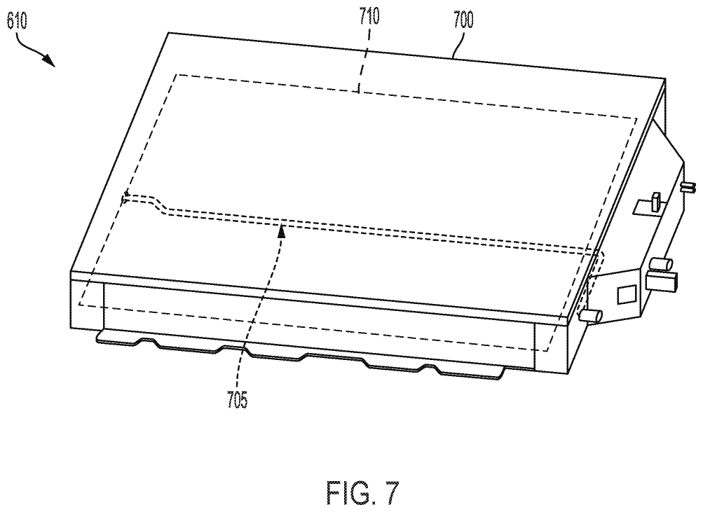

FIG. 7 depicts an example battery pack 610. Referring to FIG. 7, among others, the battery pack 610 can provide power to electric vehicle 605. Battery packs 610 can include any arrangement or network of electrical, electronic, mechanical or electromechanical devices to power a vehicle of any type, such as the electric vehicle 605. The battery pack 610 can include at least one housing 700. The housing 700 can include at least one battery module 615 or at least one battery cell 620, as well as other battery pack components. The battery module 615 can be or can include one or more groups of prismatic cells, cylindrical cells, pouch cells, or other form factors of battery cells 620. The housing 700 can include a shield on the bottom or underneath the battery module 615 to protect the battery module 615 and/or cells 620 from external conditions, for example if the electric vehicle 605 is driven over rough terrains (e.g., off-road, trenches, rocks, etc.) The battery pack 610 can include at least one cooling line 705 that can distribute fluid through the battery pack 610 as part of a thermal/temperature control or heat exchange system that can also include at least one thermal component (e.g., cold plate) 710. The thermal component 710 can be positioned in relation to a top submodule and a bottom submodule, such as in between the top and bottom submodules, among other possibilities. The battery pack 610 can include any number of thermal components 710. For example, there can be one or more thermal components 710 per battery pack 610, or per battery module 615. At least one cooling line 705 can be coupled with, part of, or independent from the thermal component 710.

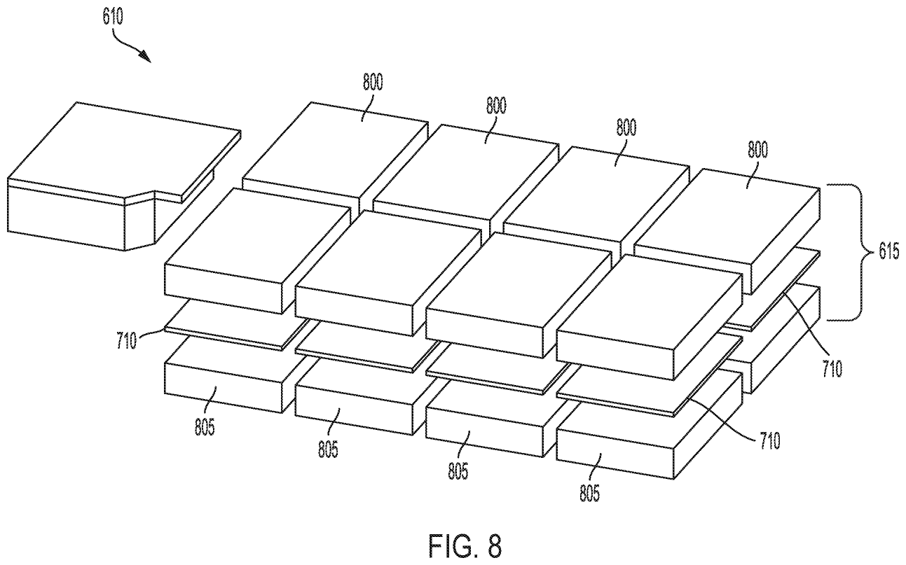

FIG. 8 depicts example battery modules 615, and FIGS. 9, 10 and 11 depict an example cross sectional view of a battery cell 620. The battery modules 615 can include at least one submodule. For example, the battery modules 615 can include at least one first (e.g., top) submodule 800 or at least one second (e.g., bottom) submodule 805. At least one thermal component 710 can be disposed between the top submodule 800 and the bottom submodule 805. For example, one thermal component 710 can be configured for heat exchange with one battery module 615. The thermal component 710 can be disposed or thermally coupled between the top submodule 800 and the bottom submodule 805. One thermal component 710 can also be thermally coupled with more than one battery module 615 (or more than two submodules 800, 805). The thermal components 710 shown adjacent to each other can be combined into a single thermal component 710 that spans the size of one or more submodules 800 or 805. The thermal component 710 can be positioned underneath submodule 800 and over submodule 805, in between submodules 800 and 805, on one or more sides of submodules 800/805, among other possibilities. The thermal component 710 can be disposed in sidewalls, cross members, structural beams, among various other components of the battery pack, such as battery pack 610 described above. The battery submodules 800, 805 can collectively form one battery module 615. In some examples each submodule 800, 805 can be considered as a complete battery module 615, rather than a submodule.

The battery modules 615 can each include a plurality of battery cells 620. The battery modules 615 can be disposed within the housing 700 of the battery pack 610. The battery modules 615 can include battery cells 620 that are cylindrical cells or prismatic cells, for example. The battery module 615 can operate as a modular unit of battery cells 620. For example, a battery module 615 can collect current or electrical power from the battery cells 620 that are included in the battery module 615 and can provide the current or electrical power as output from the battery pack 610. The battery pack 610 can include any number of battery modules 615. For example, the battery pack can have one, two, three, four, five, six, seven, eight, nine, ten, eleven, twelve or other number of battery modules 615 disposed in the housing 700. It should also be noted that each battery module 615 may include a top submodule 800 and a bottom submodule 805, possibly with a thermal component 710 in between the top submodule 800 and the bottom submodule 805. The battery pack 610 can include or define a plurality of areas for positioning of the battery module 615 and/or cells 620. The battery modules 615 can be square, rectangular, circular, triangular, symmetrical, or asymmetrical. In some examples, battery modules 615 may be different shapes, such that some battery modules 615 are rectangular but other battery modules 615 are square shaped, among other possibilities. The battery module 615 can include or define a plurality of slots, holders, or containers for a plurality of battery cells 620. It should be noted the illustrations and descriptions herein are provided for example purposes and should not be interpreted as limiting. For example, the battery cells 620 can be inserted in the battery pack 610 without battery modules 800 and 805. The battery cells 620 can be disposed in the battery pack 610 in a cell-to-pack configuration without modules 800 and 805, among other possibilities.

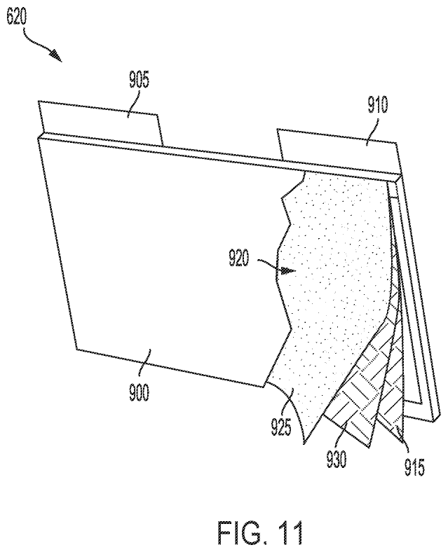

Battery cells 620 have a variety of form factors, shapes, or sizes. For example, battery cells 620 can have a cylindrical, rectangular, square, cubic, flat, pouch, elongated or prismatic form factor. As depicted in FIG. 9, for example, the battery cell 620 can be cylindrical. As depicted in FIG. 10, for example, the battery cell 620 can be prismatic. As depicted in FIG. 11, for example, the battery cell 620 can include a pouch form factor. Battery cells 620 can be assembled, for example, by inserting a winded or stacked electrode roll (e.g., a jelly roll) including electrolyte material into at least one battery cell housing 900. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 620 can include an electrolyte layer where the electrolyte layer can be or include solid electrolyte material that can conduct ions, such as negatively charged particles (e.g., electrons), positively charged particles (e.g., protons), cations, anions, negatively charged molecules or atoms, positively charged molecules or atoms, or some other ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 620. The housing 900 can be of various shapes, including cylindrical or rectangular, for example. Electrical connections can be made between the electrolyte material and components of the battery cell 620. For example, electrical connections to the electrodes with at least some of the electrolyte material can be formed at two points or areas of the battery cell 620, for example to form a first polarity terminal 905 (e.g., a positive or anode terminal) and a second polarity terminal 910 (e.g., a negative or cathode terminal). The polarity terminals can be made from electrically conductive materials to carry electrical current from the battery cell 620 to an electrical load, such as a component or system of the electric vehicle 605.

For example, the battery cell 620 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 620 to separate the anode and cathode from each other and to facilitate transfer of lithium ions between the anode and cathode. It should be noted that battery cell 620 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 620 can be included in battery modules 615 or battery packs 610 to power components of the electric vehicle 605. The battery cell housing 900 can be disposed in the battery module 615, the battery pack 610, or a battery array installed in the electric vehicle 605. The housing 900 can be of any shape, such as cylindrical with a circular (e.g., as depicted in FIG. 9, among others), elliptical, or ovular base, among others. The shape of the housing 900 can also be prismatic with a polygonal base, as shown in FIG. 10, among others. As shown in FIG. 11, among others, the housing 900 can include a pouch form factor. The housing 900 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 900 of the battery cell 620 can include one or more materials with various electrical conductivity or thermal conductivity, or a combination thereof. The electrically conductive and thermally conductive material for the housing 900 of the battery cell 620 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 900 of the battery cell 620 can include a ceramic material (e.g., silicon nitride, silicon carbide, titanium carbide, zirconium dioxide, and among others) and a thermoplastic material (e.g., polyethylene, polypropylene, polystyrene, polyvinyl chloride, or nylon), among others. In examples where the housing 900 of the battery cell 620 is prismatic (e.g., as depicted in FIG. 10, among others) or cylindrical (e.g., as depicted in FIG. 9, among others), the housing 900 can include a rigid or semi-rigid material such that the housing 900 is rigid or semi-rigid (e.g., not easily deformed or manipulated into another shape or form factor). In examples where the housing 900 includes a pouch form factor (e.g., as depicted in FIG. 11, among others), the housing 900 can include a flexible, malleable, or non-rigid material such that the housing 900 can be bent, deformed, manipulated into another form factor or shape.

The battery cell 620 can include at least one anode layer 915, which can be disposed within the cavity 920 defined by the housing 900. The anode layer 915 can be an electrode 100 as herein described or some other electrode. The anode layer 915 can include a first redox potential. The anode layer 915 can receive electrical current into the battery cell 620 and output electrons during the operation of the battery cell 620 (e.g., charging or discharging of the battery cell 620). The anode layer 915 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material (e.g., the current collector material 105). For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 620 can include at least one cathode layer 925 (e.g., a composite cathode layer compound cathode layer, a compound cathode, a composite cathode, or a cathode). The cathode layer 925 can be an electrode 100 as herein described or some other electrode. The cathode layer 925 can include a second redox potential that can be different than the first redox potential of the anode layer 915. The cathode layer 925 can be disposed within the cavity 920. The cathode layer 925 can output electrical current out from the battery cell 620 and can receive electrons during the discharging of the battery cell 620. The cathode layer 925 can also release lithium ions during the discharging of the battery cell 620. Conversely, the cathode layer 925 can receive electrical current into the battery cell 620 and can output electrons during the charging of the battery cell 620. The cathode layer 925 can receive lithium ions during the charging of the battery cell 620.

The battery cell 620 can include an electrolyte layer 930 disposed within the cavity 920. The electrolyte layer 930 can be arranged between the anode layer 915 and the cathode layer 925 to separate the anode layer 915 and the cathode layer 925. The electrolyte layer 930 can help transfer ions between the anode layer 915 and the cathode layer 925. The electrolyte layer 930 can transfer Li⁺ cations from the anode layer 915 to the cathode layer 925 during the discharge operation of the battery cell 620. The electrolyte layer 930 can transfer lithium ions from the cathode layer 925 to the anode layer 915 during the charge operation of the battery cell 620.

The redox potential of layers (e.g., the first redox potential of the anode layer 915 or the second redox potential of the cathode layer 925) can vary based on a chemistry of the respective layer or a chemistry of the battery cell 620. For example, lithium-ion batteries can include an LFP (lithium iron phosphate) chemistry, LMFP (lithium manganese, iron phosphate) chemistry, an NMC (Nickel Manganese Cobalt) chemistry, an NCA (Nickel Cobalt Aluminum) chemistry, an OLO (overlithiated oxide) chemistry, or an LCO (lithium cobalt oxide) chemistry for a cathode layer (e.g., the cathode layer 925). Lithium-ion batteries can include a graphite chemistry, a silicon-graphite chemistry, or a lithium metal chemistry for the anode layer (e.g., the anode layer 915).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), a layered oxides (LiMO₂, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 925). Lithium-ion batteries can include a graphite chemistry, a silicon-graphite chemistry, or a lithium metal chemistry for the anode layer (e.g., the anode layer 915). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers, such as the electrode 100, can include an active material, such as those described above. For example, electrode layers can include an anode active material or cathode active material, commonly in addition to a conductive material, a binder, other additives as a coating on a current collector, such as the current collector material 105. The chemical composition of the electrode layers can affect the redox potential of the electrode layers. For example, cathode layers (e.g., the cathode layer 925) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 915) can include conductive materials such as carbon, graphite, carbon black, carbon nanotubes, a conductive polymer, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). For example, and as described above, binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

The electrolyte layer 930 can include or be made of a liquid electrolyte material. For example, the electrolyte layer 930 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 930 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 930 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 930 includes a liquid electrolyte material, the electrolyte layer 930 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 930 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 930 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 930 from greater than 0 M to about 1.5 M.

FIG. 11, among others, depicts an example method 1100 of providing an electrode. The method 1100 can include providing the electrode 100 at ACT 1105. The electrode 100 can include the first electrode layer 120 applied to the current collector material 105. The electrode 100 can include the second electrode layer 125 applied to the first electrode layer 120. For example, the electrode 100 can include the first electrode layer 120 including a first solid content comprising a first proportion of the first electrode layer 120. The second electrode layer 125 can include a second solid content comprising a second proportion of the second electrode layer 125, where the second proportion is less than the first proportion. The first electrode layer 120 can include a first applied viscosity (e.g., a viscosity as the first electrode layer 120 is applied to the current collector material 105 in an uncured form). The second electrode layer 125 can include a second applied viscosity that is less than the first applied viscosity. The electrode 100 can include a first electrode layer 120 applied to each side 110, 115 of the current collector material 105 and a second electrode layer 125 applied to each of the first electrode layers 120. For example, the electrode can include an upper first electrode layer 120 applied to the first side 110 of the current collector material 105 and a lower first electrode layer 120 applied to the second side 115 of the current collector material 105. The electrode can include an upper second electrode layer 125 applied to the upper first electrode layer 120 and a lower second electrode layer 125 applied to the lower first electrode layer 120. The electrode 100 can include at least one buffer layer 200. For example, the electrode can include a buffer layer 200 positioned between the first electrode layer 120 and the current collector material 105. The electrode 100 can include a buffer layer 200 positioned between the first electrode layer 120 and the second electrode layer 125. The buffer layer 200 can include a binder material and a conductive material, but no active material. The buffer layer 200 can improve an adhesion of the first electrode layer 120 to the current collector material 105 or improve an adhesion of the second electrode layer 125 to the first electrode layer 120. The buffer layer 200 can improve a conductivity of the first electrode layer 120 or the second electrode layer 125. The electrode 100 can be used in a batter cell, such as the battery cell 620 of the electric vehicle 605.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a current collector material including a first side;
a first electrode layer applied to the first side of the current collector material, the first electrode layer including a first applied viscosity of a first slurry; and
a second electrode layer applied to the first electrode layer, the second electrode layer including a second applied viscosity of a second slurry;
wherein the first applied viscosity of the first slurry is greater than the second applied viscosity of the second slurry.

2. The apparatus of claim 1, comprising:
the first electrode layer including a first solid content by weight;
the second electrode layer including a second solid content by weight;
wherein the first solid content by weight is greater than the second solid content by weight.

3. The apparatus of claim 1, wherein the first applied viscosity of the first slurry is at least 7,000 centipoise.

4. The apparatus of claim 1, comprising:
a first solid content of the first electrode layer including a first binder material having first molecular weight; and
a second solid content of the second electrode layer including a second binder material having a second molecular weight that is less than the first molecular weight.

5. The apparatus of claim 1, comprising:
a first solid content of the first electrode layer including a first conductive material having a first conductivity; and
a second solid content of the second electrode layer including a second conductive material having a second conductivity that is less than the first conductivity.

6. The apparatus of claim 1, comprising:
a first solid content of the first electrode layer including a first porosity; and
a second solid content of the second electrode layer including a second porosity, the first porosity that is greater than the second porosity.

7. The apparatus of claim 1, comprising:
a first solid content of the first electrode layer including a first proportion of a first active material, the first active material having a first chemistry; and
a second solid content of the second electrode layer including a second proportion of a second active material, the second active material having a second chemistry that is different than the first chemistry;
wherein the second proportion is greater than the first proportion.

8. The apparatus of claim 1, comprising:
a first solid content of the first electrode layer including a first active material having a first chemistry; and
a second solid content of the second electrode layer including a second active material having a second chemistry different than the first chemistry.

9. The apparatus of claim 1, comprising:
a first solid content of the first electrode layer including a first active material having a nickel-based chemistry; and
a second solid content of the second electrode layer including a second active material having an Olivine-based chemistry.

10. The apparatus of claim 1, comprising:
a buffer layer positioned between the first side of the current collector material and the first electrode layer, the buffer layer including a binder material to adhere the first electrode layer to the first side of the current collector material.

11. The apparatus of claim 1, comprising:
a buffer layer positioned between the first electrode layer and the second electrode layer, the buffer layer including a conductive material to conduct ions between the first electrode layer and the second electrode layer.

12. The apparatus of claim 1, comprising:
the first electrode layer having a first thickness and the second electrode layer having a second thickness; and
a buffer layer positioned between the first side of the current collector material and the first electrode layer, the buffer layer including a third thickness and a binder material to adhere the first electrode layer to the first side of the current collector material, wherein the third thickness is less than the first thickness and the second thickness.

13. The apparatus of claim 1, comprising:
the first electrode layer having a first thickness and the second electrode layer having a second thickness; and
a buffer layer positioned between the first electrode layer and the second electrode layer, the buffer layer including a third thickness and a conductive material to conduct ions between the first electrode layer and the second electrode layer, wherein the third thickness is less than the first thickness and the second thickness.

14. The apparatus of claim 1, comprising:
a first buffer layer positioned between the first side of the current collector material and the first electrode layer, the first buffer layer including a binder material to adhere of the first electrode layer to the first side of the current collector material; and
a second buffer layer positioned between the first electrode layer and the second electrode layer, the second buffer layer including a conductive material to conduct ions between the first electrode layer and the second electrode layer.

15. A method, comprising:
providing a current collector material including a first side;
applying a first electrode layer to the first side of the current collector material, the first electrode layer including a first applied viscosity of a first slurry and a first solid content by weight; and
applying a second electrode layer to the first electrode layer, the second electrode layer including a second applied viscosity of a second slurry and a second solid content by weight;
wherein the first solid content by weight is greater than the second solid content by weight and the first applied viscosity of the first slurry is greater than the second applied viscosity of the second slurry.

16. The method of claim 15, comprising:
applying a buffer layer between the first side of the current collector material and the first electrode layer, the buffer layer including a binder material to adhere the first electrode layer to the first side of the current collector material.

17. The method of claim 15, comprising:
applying a buffer layer between the first electrode layer and the second electrode layer, the buffer layer including a conductive material to conduct ions between the first electrode layer and the second electrode layer.

18. The method of claim 15, wherein the first electrode layer includes a first thickness and the second electrode layer having a second thickness, the method comprising:
applying a buffer layer between the first electrode layer and the second electrode layer, the buffer layer including a third thickness and a conductive material to conduct ions between the first electrode layer and the second electrode layer, wherein the third thickness is less than the first thickness and the second thickness.

19. A battery cell, comprising:
a battery electrode, comprising:
a current collector material including a first side;
a first electrode layer applied to the first side of the current collector material, the first electrode layer including a first solid content by weight and a first applied viscosity of a first slurry; and
a second electrode layer applied to the first electrode layer, the second electrode layer including a second solid content by weight and a second applied viscosity of a second slurry;
wherein the first solid content by weight is greater than the second solid content by weight and the first applied viscosity of the first slurry is greater than the second applied viscosity of the second slurry.

20. The battery cell of claim 19, wherein the first electrode layer includes a first thickness and the second electrode layer having a second thickness, the battery electrode comprising:
a buffer layer positioned between the first electrode layer and the second electrode layer, the buffer layer including a third thickness and a conductive material to conduct ions between the first electrode layer and the second electrode layer, wherein the third thickness is less than the first thickness and the second thickness.
